(19) United States
(12) Patent Application Publication
(10) Pub. No.: US 2009/0180478 A1
(43) Pub. Date: Jul. 16, 2009

(54) ETHERNET SWITCHING METHOD AND ETHERNET SWITCH

(76) Inventors: Yang YU, Hangzhou (CN); Wei WANG, Hangzhou (CN); Jinglin LI, Hangzhou (CN); Chushun WEI, Hangzhou (CN)

Correspondence Address: LADAS & PARRY LLP, 224 SOUTH MICHIGAN AVENUE, SUITE 1600, CHICAGO, IL, 60604, US

(21) Appl. No.: 12/346,039

(22) Filed: Dec. 30, 2008

Related U.S. Application Data
(63) Continuation of application No. PCT/CN2007/070543, filed on Aug. 23, 2007.

(30) Foreign Application Priority Data
Dec. 26, 2006 (CN) 200610172769.7
Dec. 28, 2006 (CN) 200610156713.2
Dec. 28, 2006 (CN) 200610156714.7

(51) Int. Cl. H04L 12/56

(52) U.S. Cl. 370/395.1; 370/395.62

(57) ABSTRACT

The present invention discloses an Ethernet switching method, including: dividing a communication period of a transmitting component of an Ethernet port into at least two equal transmission time slots that appear regularly; deciding a transmission time slot at the Ethernet port corresponding to the Layer 2/Layer 3 (L2/L3) information of a to-be-switched Ethernet frame of fixed length; switching the to-be-switched Ethernet frame of fixed length into a time-division switch transmission queue maintained by the decided Ethernet port in the decided transmission time slot; and transmitting, by the Ethernet port in a cyclic order, to-be-switched Ethernet frames of fixed length in time-division switch transmission queues maintained in different transmission time slots separately. The present invention also discloses an Ethernet switch. The Ethernet switching scheme provided by the present invention satisfies the transmission delay requirement of time-division services transmitted at constant rate.

### FIELD OF THE TECHNOLOGY

The present invention relates to service data packet switching technology, and particularly, to an Ethernet switching method and an Ethernet switch.

### BACKGROUND OF THE INVENTION

The data services in the domain of data switching of the conventional network can be divided into burst services and time-division services. The burst services are data services transmitted at non-constant rate which allows comparatively greater end-to-end transmission delay variation; and the time-division services are data services transmitted at constant rate which allows smaller end-to-end transmission delay variation.

Data in the burst services are usually transmitted via packet switching technology on Layer 2/Layer 3 (L2/L3) at present. Such switching technology has the advantages of high bandwidth efficiency and low cost. Ethernet switches such as Local Area Network (LAN) Switches are widely used as important packet switch devices in LAN as well as in Metropolitan Area Network (MAN).

FIG. 1 is a schematic diagram illustrating the structure of a conventional Ethernet switch. As shown in FIG. 1, the Ethernet Switch 100 includes Switch Unit 110 and at least two Ethernet Ports 120.

Each Ethernet Port 120 is a bi-directional port and includes two parts: a receiving component that receives data and a transmitting component that transmits data. The Ethernet Port 120 sends the incoming Ethernet frames received via the receiving component to the Switch Unit 110 which extracts L2 or L3 information, hereinafter named L2/L3 information, from the received Ethernet frames. After that, the Ethernet frames received via the receiving component of the Ethernet Port 120 are switched into the transmission queue maintained by the transmitting component of the Ethernet Port 120 according to relations recorded in the forwarding table between the L2/L3 information and the Ethernet ports. The transmission queue buffers the Ethernet frames to be transmitted by the Ethernet port. In the outgoing transmission process, the transmitting component of the Ethernet port transmits the Ethernet frames in the transmission queue separately.

It can be seen that the Ethernet switch adopts packet switch technology based on the relations between the L2/L3 information and the Ethernet ports in the forwarding table. The L2 information may include source and destination Media Access Control (MAC) addresses and Virtual Local Area Network Identifier (VLAN ID); and the L3 information may include source and destination Internet Protocol (IP) addresses.

The present Ethernet Port 120 of the Ethernet Switch 100 usually adopts priority algorithm to ensure that the Ethernet frame of the highest priority shall be sent out first. The Ethernet Ports 120 in FIG. 1 usually maintains a number of transmission queues of different priority levels, the priority levels of the transmission queues can be fixed or flexible and the queues support the buffer structure of First In First Out (FIFO) algorithm. While reading the Ethernet frames in the transmission queues, the Ethernet Ports 120 first select the transmission queue of the highest priority level from all maintained transmission queues and then read the Ethernet frames in the selected queue according to the FIFO principle. The forwarding table in the Switch Unit 110 saves the relations between the destination addresses and the transmission queues at the Ethernet ports. A transmission queue at an Ethernet ports is specified to indicate the specific Ethernet port and the specific transmission queue.

Table 1 is a forwarding table in the present Ethernet switching technology.

TABLE 1

| Entry | Destination MAC | Other | → | Transmission queue 8 at the | Other |
|---|---|---|---|---|---|
| 1 | Address A | attributes | | Ethernet Port 9 | action |
| Entry | Destination MAC | Other | → | Transmission queue 3 at the | Other |
| 2 | Address B | attributes | | Ethernet Port 7 | action |

. . .

| | | | | | |
|---|---|---|---|---|---|
| Entry | Destination MAC | Other | → | Transmission queue 4 at the | Other |
| N | Address X | attributes | | Ethernet Port 1 | action |

As shown in Table 1, the forwarding table in the conventional Ethernet switching technology consists of multiple table entries and every entry includes two parts: the attributes of the data frame/packet, e.g., the L2/L3 information such as the destination MAC address, the destination IP address or the VLAN ID; and the action to be taken with the data frame/packet that has the attribute(s) specified in the table entry, e.g., forwarding the data frame/packet to a transmission queue at an Ethernet port (or to transmission queues maintained by different Ethernet ports separately in multicast) or modifying some fields. The attribute “destination MAC address” and the action “forward to transmission queue X at Ethernet port Y” in the forwarding table shown in Table 1 make up the relation based on which the forwarding action is executed. When an Ethernet frame is forwarded based on the forwarding table, the forwarding table shall be searched based on the destination MAC address of the Ethernet frame to find the action instruction “forward to transmission queue X at Ethernet port Y” which corresponds to the destination MAC address of the Ethernet frame, then the Ethernet frame is sent to the specified transmission queue at the specified Ethernet port so that the Ethernet port may read the Ethernet frame according to a priority policy and output the Ethernet frame. Before sending the Ethernet frame to the corresponding transmission queue, the Ethernet frame can be modified according to other actions specified in the forwarding table, e.g., an action to modify a field.

The forwarding table entries in Table 1 may be set as being unable to be updated automatically or being able to be updated automatically. When the table entries can be updated automatically, the destination addresses and actions recorded in the table entries are subject to the influences of automatic learning and aging; when the table entries can not be updated automatically, the destination addresses and actions recorded in the table entries are independent of the influences of automatic learning and aging and can only be updated by the system administrator.

It can be seen from the Ethernet searching/forwarding theory described above the present Ethernet switch transmits the Ethernet frames in the maintained transmission queue one by one according to the FIFO principle. The switching delay of an Ethernet frame, i.e., the time period between receiving an Ethernet frame and transmitting the Ethernet frame, is affected by both the length of the Ethernet frame and the transmission queue in which the Ethernet frame is located. Longer Ethernet frame will have longer switching delay; or, when many Ethernet frames or long Ethernet frames are queuing before an Ethernet frame in a transmission queue, the Ethernet frame will have longer switching delay. Inconstant switching delay makes it impossible to transmit Ethernet frames at regular intervals. In addition, the Ethernet frames in the same queue may belong to different service streams. For example, the 1^{st}, 3^{rd}, 4^{th} and 7^{th} Ethernet frames in a transmission queue belong to one service stream while other Ethernet frames in the transmission queue belong to other service streams, hence the Ethernet frames of one service stream cannot be transmitted at regular intervals, the end-to-end transmission delay variation thus emerges and the Quality of Service (QoS) is not satisfied. Time-division services usually have strict end-to-end transmission delay variation requirements and demand time-division switching that ensures transmission at constant rate.

### SUMMARY OF THE INVENTION

In view of the above, an embodiment of the present invention provides an Ethernet switching method to meet the transmission delay requirement of time-division services which are transmitted at constant rate.

The method includes:

dividing the communication period of the transmitting component of an Ethernet port into at least two time-division services switch slots that appear regularly;

deciding a transmission time slot at the Ethernet port corresponding to the Layer 2/Layer 3 (L2/L3) information of a to-be-switched Ethernet frame of fixed length; switching the to-be-switched Ethernet frame of fixed length into the time-division switch transmission queue maintained by the decided Ethernet port in the decided transmission time slot; and

transmitting, by the Ethernet port in a cyclic order, to-be-switched Ethernet frames of fixed length in time-division services switch transmission queues maintained in different transmission time slots separately.

An embodiment of the present invention provides an Ethernet switch to meet the transmission delay requirement of time-division services transmitted at constant rate.

The Ethernet switch includes setup unit, switch unit and at least two Ethernet ports; wherein

the setup unit is adapted to divide a communication period of a transmitting component of every Ethernet port into at least two equal transmission time slots that appear regularly, and to send the relations between the L2/L3 information and the transmission time slots of the Ethernet ports to the switch unit;

the switch unit is adapted to determine, based on the received relations, the transmission time slot at the Ethernet port corresponding to the Layer 2/Layer 3 (L2/L3) information of a to-be-switched Ethernet frame of fixed length, and to switch the to-be-switched Ethernet frame of fixed length into a time-division switch transmission queue maintained by the determined Ethernet port in the determined transmission time slot; and

an Ethernet port is adapted to transmit in a cyclic order the to-be-switched Ethernet frames of fixed length in time-division switch transmission queues maintained in different transmission time slots separately; further, it is also adapted to receive the frame and send the frame to the switch unit.

The Ethernet switching method provided by the present invention satisfies the transmission delay requirement of time-division services transmitted at constant rate. To be specific, the present invention has the following benefits:

An Ethernet port in accordance with the present invention is divided into at least two transmission time slots of the same length and to-be-transmitted Ethernet frames of fixed length are switched to the queue of the transmission time slots at the Ethernet ports corresponding to the L2/L3 information of the Ethernet frames, since the Ethernet frames of fixed length in a transmission time slot are transmitted when the regular transmission interval of the transmission time slot expires, the method of the present invention meets the transmission delay requirement of time-division services transmitted at constant rate over Ethernet. The length of the Ethernet frames is fixed and the transmission periods of the transmission time slots are due regularly in a cyclic order, therefore the transmission delay of an Ethernet frame of fixed length will always remain unchanged. In addition, the transmission time slots can be associated with service streams so that the Ethernet frames of one same service stream can be transmitted at regular intervals and the transmission rate of the service stream remains constant, in this way the Quality of Service (QoS) is ensured. It can be seen that the Ethernet switching method of the present invention allows time-division services to be transmitted at constant rate over Ethernet while keeping the present Ethernet switching mechanism.

### BRIEF DESCRIPTION OF THE DRAWINGS

FIG. 1 is a schematic illustrating the structure of a conventional Ethernet switch;

FIG. 2 is a flow chart of the Ethernet switching method in accordance with the present invention;

FIG. 3 is a flow chart of the Ethernet switching method in Embodiment 1 of the present invention;

FIG. 4 is a schematic illustrating the time slot division of an Ethernet port in Embodiment 1 of the present invention;

FIG. 5 is a schematic diagram of the Ethernet synchronized time-division switching in Embodiment 1 of the present invention;

FIG. 6 is a schematic diagram illustrating the transmission queue at the transmitting component of an Ethernet port in an embodiment of the present invention;

FIG. 7 is a schematic illustrating the structure of an Ethernet frame in accordance with IEEE802.3;

FIG. 8 is a schematic illustrating the structure of an Ethernet frame of fixed length in Embodiment 1 of the present invention;

FIG. 9 is a schematic illustrating the construction of an Ethernet frame of fixed length by using IP message fragment in Embodiment 1 of the present invention;

FIG. 10 is a schematic illustrating the extended frame header of an Ethernet frame of fixed length in Embodiment 1 of the present invention;

FIG. 11 is a schematic illustrating the construction of an Ethernet frame of fixed length by using MAC frame fragment in Embodiment 1 of the present invention;

FIG. 12 is a flow chart of the Ethernet switching method in Embodiment 2 of the present invention;

FIG. 13 is a schematic illustrating the transmission queue at the transmitting component of an Ethernet port in Embodiment 2 of the present invention;

FIG. 14 is a flow chart of transmitting Ethernet frames of fixed length/Ethernet frames in Step 1206 of FIG. 12;

FIG. 15 is a schematic illustrating the structure of the Ethernet switch in Embodiment 1 of the present invention;

FIG. 16 is a schematic illustrating the structure of the transmitting component of Ethernet Port 1430 in FIG. 15; and

FIG. 17 is a schematic illustrating another kind of structure of the transmitting component of Ethernet Port 1430 in FIG. 15.

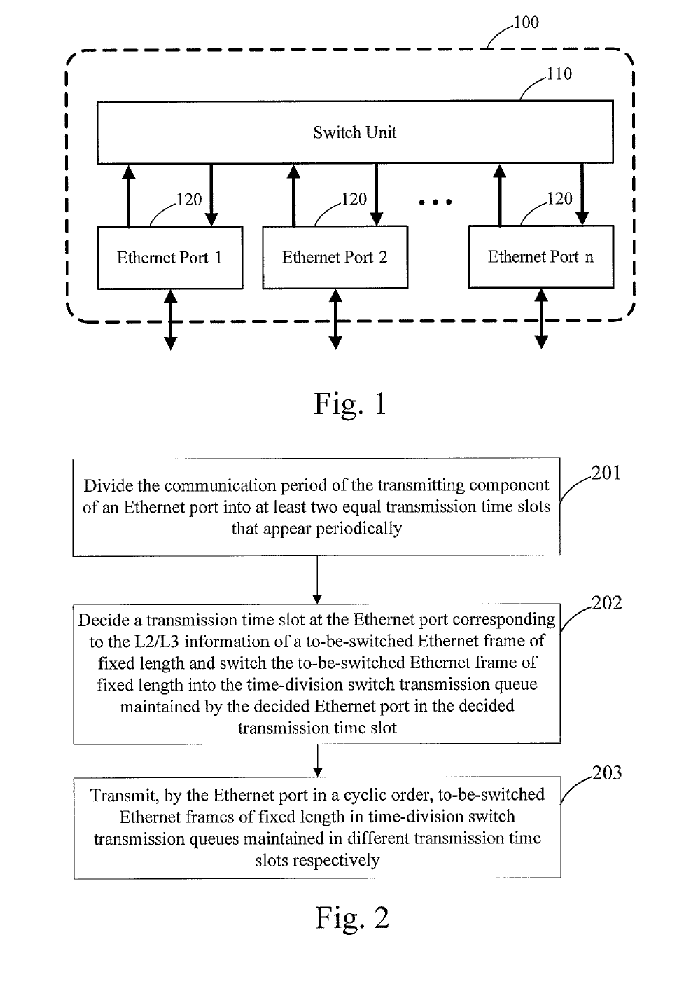

### DETAILED DESCRIPTION OF THE INVENTION

The present invention is hereinafter described in detail with reference to the accompanying drawings and embodiments.

The present invention provides an Ethernet switching scheme, including: achieving synchronized time-division switching over widely adopted Ethernet by dividing the communication period of Ethernet ports into time slots and using Ethernet frames of fixed length, so that the transmission delay requirement of time-division services transmitted at constant rate can be satisfied.

An embodiment of the present invention provides an Ethernet switching method to meet the transmission delay requirement of time-division services which are transmitted at constant rate. The method includes:

dividing the communication period of the transmitting component of an Ethernet port into at least two equal transmission time slots that appear regularly; assigning one or more transmission time slots to time-division services switch (called time-division switching slot) and one or more transmission time slots to burst services packet switch (called packet switching slot); deciding a transmission time slot at the Ethernet port corresponding to the Layer 2/Layer 3 (L2/L3) information of a to-be-switched Ethernet frame of fixed length; switching the to-be-switched Ethernet frame of time-division services into the time-division switch transmission queue maintained by the decided Ethernet port in the decided transmission time slot; switching a to-be-switched Ethernet frame of burst services packet into packet switch transmission queue maintained by corresponding Ethernet port; transmitting, by the Ethernet port in the cyclic order of the transmission time slots, to-be-switched Ethernet frames of time-division services in time-division switch transmission queues maintained in different time-division switching slots; and transmitting to-be-switched Ethernet frames in packet switch transmission queues maintained in different packet switching slots.

Another embodiment of the present invention provides another Ethernet switching method to meet the transmission delay requirement of time-division services which are transmitted at constant rate. The method includes:

dividing the communication period of the transmitting component of every Ethernet port into at least two equal transmission time slots that appear regularly, wherein the transmission time slots of Ethernet ports with the same rate are equal in length and the number of transmission time slots of an Ethernet port whose transmission rate is the multiple of the rate of a second Ethernet port is the multiple of the number of transmission time slots of the second Ethernet port while keeping the same cyclic period of time; deciding a transmission time slot at the Ethernet port corresponding to the Layer 2/Layer 3 (L2/L3) information of a to-be-switched Ethernet frame of fixed length; switching the to-be-switched Ethernet frame of fixed length into the time-division switch transmission queue maintained by the decided Ethernet port in the decided transmission time slot; and transmitting, by the Ethernet port in a cyclic order, to-be-switched Ethernet frames of fixed length in time-division switch transmission queues maintained in different transmission time slots separately.

Another embodiment of the present invention further provides a method for encapsulating Ethernet frames of fixed length in Ethernet switching so as to produce Ethernet frames of fixed length to carry time-division service data in the Ethernet switching executed by using the method of the present invention, therefore the transmission delay requirement of time-division services transmitted at constant rate can be satisfied. The method includes: deciding the length and format of Ethernet frames of fixed length; and encapsulating to-be-transmitted data into Ethernet frames of fixed length based on the decided length and format.

Another embodiment of the present invention provides another method for encapsulating Ethernet frames in Ethernet switching so as to produce Ethernet frames of fixed length to carry time-division service data in the Ethernet switching executed by using the method of the present invention, therefore the transmission delay requirement of time-division services transmitted at constant rate can be satisfied. The frame header of an Ethernet frame shall be extended to include a fragment type that identifies the Ethernet frame of fixed length as a fragment, and a fragment offset that indicates the location of the Ethernet frame in the fragmented to-be-transmitted data. The method includes:

based on the length of to-be-transmitted IP message and the fixed length of Ethernet frame, determining the number m of the fragments to be obtained, wherein m is an integer larger than 1 or equal to 1; dividing the to-be-transmitted data encapsulated in an IP message into m IP message fragments; and encapsulating the IP message fragments into Ethernet frames of predetermined length based on the information in the extended frame header.

Embodiments of the present invention will be hereinafter described more detailedly.

FIG. 2 is a flow chart of the Ethernet switching method in accordance with the present invention. As shown in FIG. 2, the method includes:

Step 201: dividing the communication period of the transmitting component of an Ethernet port into at least two equal transmission time slots that appear periodically;

Step 202: deciding a transmission time slot at the Ethernet port corresponding to the L2/L3 information of a to-be-switched Ethernet frame of fixed length; switching the to-be-switched Ethernet frame of fixed length into the time-division switch transmission queue maintained in the decided transmission time slot of the Ethernet port; and

Step 203: transmitting, by the Ethernet port in a cyclic order, to-be-switched Ethernet frames of fixed length in time-division switch transmission queues maintained in different transmission time slots separately.

It can be seen from the flow shown in FIG. 2 that the Ethernet switching method of the present invention achieves time-division multiplexing on Ethernet ports by dividing the communication time of the transmitting components of the Ethernet ports into time slots. Based on that, the Ethernet switch switches the Ethernet frames of fixed length to corresponding time slots at corresponding Ethernet ports according to the L2/L3 information of the Ethernet frames so that the switched Ethernet frames can be transmitted periodically through the time slots. Since the length of the Ethernet frames is fixed and the Ethernet frames are transmitted regularly through the transmission time slots in a cyclic order, the transmission delay of an Ethernet frame of fixed length will always remain unchanged. In addition, the transmission time slots can be associated with service streams so that the Ethernet frames of a same service stream can be transmitted at regular intervals and the transmission rate of the service stream remains constant, in which way QoS is ensured. In this way, the time-division service streams transmitted at constant rate can be carried by Ethernet frames of fixed length and the transmission delay requirement of time-division services transmitted at constant rate can be satisfied.

The basic unit of Ethernet switching in accordance with the present invention is an Ethernet frame of fixed length, which provides a higher transmission rate than the conventional unit of bytes does in time-division switching.

And the cost of Ethernet networks is low, so the Ethernet switching method of the present invention shows higher performance/cost ratio than the conventional time-division switching scheme.

Two embodiments are hereinafter given to further describe the Ethernet switching method of the present invention.

### Embodiment 1

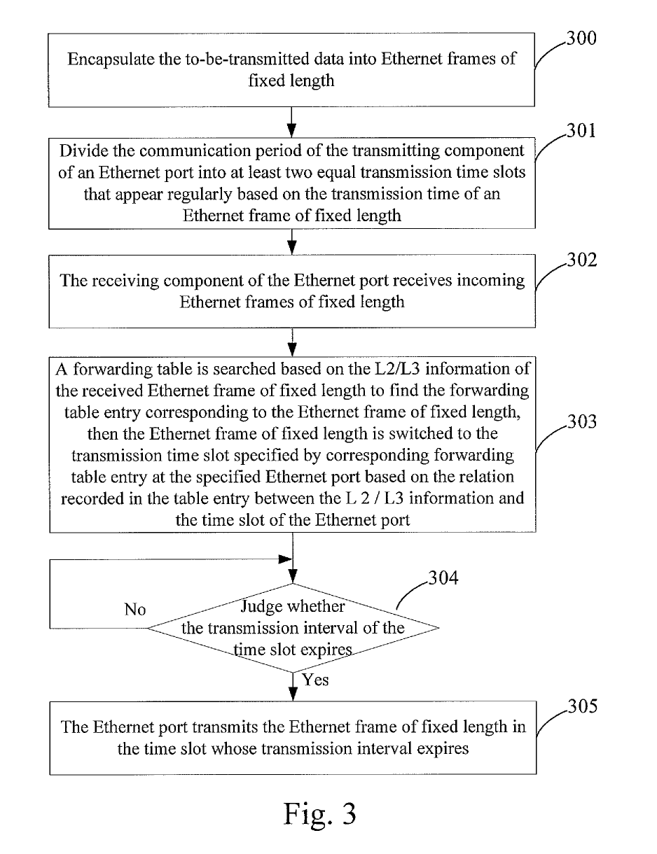

FIG. 3 is a flow chart of the Ethernet switching method in Embodiment 1 of the present invention. As shown in FIG. 3, the method includes the following steps.

Step 300: the to-be-transmitted upper layer data are encapsulated into Ethernet frames of fixed length.

First of all, time-division switching over Ethernet requires Ethernet frames of fixed length.

When the to-be-transmitted upper layer data have been encapsulated with the conventional Ethernet frame encapsulation method, if the length of the Ethernet frames of to-be-transmitted upper layer data is smaller than or equal to the length that the Ethernet frames of fixed length can carry, the to-be-transmitted upper layer data shall be encapsulated directly into Ethernet frames of fixed length; if the length of the Ethernet frames of to-be-transmitted upper layer data is larger than the length that the Ethernet frames of fixed length can carry, the to-be-transmitted upper layer data shall be fragmented by using a fragmenting method and the format of the fragments obtained shall then be converted to produce Ethernet frames of fixed length, thus the data transmission is achieved across frames.

Step 301: divide the communication period of the transmitting component of an Ethernet port into at least two equal transmission time slots that appear periodically with the transmission time of an Ethernet frame of fixed length as the basic time unit.

Among the transmission time slots obtained in this step, one transmission time slot is associated with one service stream, i.e., the Ethernet frames of fixed length carrying the same service stream will be transmitted in the same transmission time slot.

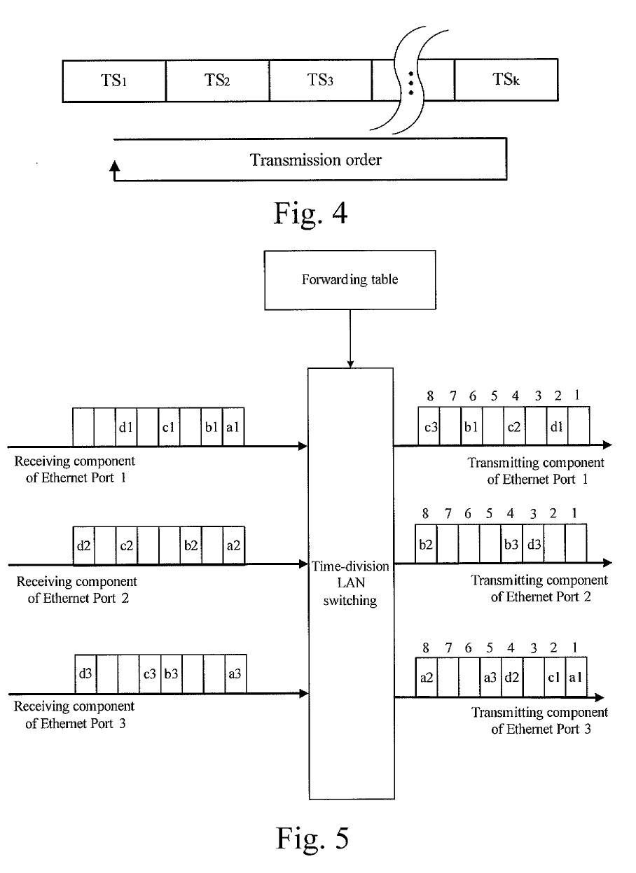

FIG. 4 is a schematic illustrating the time slot division of an Ethernet port in this embodiment. As shown in FIG. 4, the communication period of the transmitting component of an Ethernet port is divided into k transmission Time Slots (TS) of equal length, namely, TS₁, TS₂, . . . , TSₖ, wherein k>1. One TS carries an Ethernet frame of fixed length and one TS is associated with one time-division service stream. When the Ethernet port transmits the Ethernet frames carried in the time slots in a cyclic order, the time-division service stream associated with the time slots are switched regularly and one time-division service stream occupies 1/k of the bandwidth of the Ethernet port. As shown in FIG. 4, TS₁ carries time-division service stream 1, when an Ethernet frame of fixed length has been sent through TS₁, the next Ethernet frame of the fixed length in TS₁ carrying the time-division service stream 1 shall be sent after the data in the following (k−1) time slots are sent. It can be seen that TS₁, TS₂, . . . , TSₖ, appear in a cyclic order in the communication period of the Ethernet port.

When the length of the Ethernet frame of fixed length is 625 bytes (B) and the clock period in an Ethernet of 10 Mbps is 1/10=0.1 μs, one byte is transmitted every 8 clock periods, therefore the transmission period of the Ethernet frame of fixed length, i.e., 625 bytes, shall be 0.1×8×625=500 μs. In this step, 500 μs is regarded as a time unit while communication period of the transmitting component of an Ethernet port is divided into time slots. The number of the time slots can be determined based on the capacity of the system. For example, when 10 time slots of 500 μs are obtained, in the communication period of the transmitting component of the Ethernet port of 10 Mbps, the 10 time slots shall appear every second in a cyclic order for 10⁶ μS/(500 μs×10)=200 times.

An Ethernet switch may include multiple Ethernet ports of different rates. As long as the rate of some Ethernet ports is the multiple of the rate of other Ethernet ports, all of the Ethernet ports may function in the time-division switching. Ethernet ports of the same rate can transmit the same amount of Ethernet frames of fixed length in a second, and the number of the Ethernet frames transmitted by an Ethernet port whose rate is the multiple of the rate of a second Ethernet port is also the multiple of the number of the Ethernet frames transmitted by the second Ethernet port in a second. In another sentence, when the communication periods of the transmitting components of Ethernet ports are divided into transmission time slots of the same length, e.g., 10 time slots at every Ethernet port, based on the transmission time of an Ethernet frame of fixed length, the 10 time slots shall appear for the same number of times in a second at Ethernet ports of the same rate, and the number of times for which the 10 time slots shall appear in a second at an Ethernet port whose rate is the multiple of the rate of a second Ethernet port is also the multiple of the number of times for which the 10 time slots shall appear at the second Ethernet port. In other words, if the rate of an Ethernet port is n times of the rate of a second Ethernet port, the Ethernet port has n×10 slots in the same cyclic period.

Step 302: the receiving component of an Ethernet port receives incoming Ethernet frames of fixed length.

Step 303: a forwarding table is searched based on the L2/L3 information of the received Ethernet frame of fixed length to find the forwarding table entry corresponding to the Ethernet frame of fixed length, then the Ethernet frame of fixed length is switched to the transmission queue of the time slot specified by corresponding forwarding table entry at the specified Ethernet port based on the relation recorded in the table entry between the L2/L3 information and the time slot of the Ethernet port.

To be specific, before switching the Ethernet frame, the L2/L3 information shall be obtained from the received Ethernet frame of fixed length. The content(s) of the L2/L3 information to be obtained can be determined based on the configuration, e.g., the L2/L3 information may include the destination MAC address, the source MAC address, the destination IP address, the source IP address, or the VLAN ID.

After that, the forwarding table is searched based on the obtained L2/L3 information to find the forwarding table entry corresponding to the received Ethernet frame of fixed length. The forwarding table entry records the relation between the L2/L3 information and a transmission time slot at the Ethernet port. Since the Ethernet port has two or more transmission time slots, the time slot recorded in the forwarding table entry indicates a specified transmission time slot at the transmitting component of a specified Ethernet port.

Eventually, the received Ethernet frame is switched to the transmission queue of the specified time slot at the specified Ethernet port based on the found forwarding table entry. An Ethernet port may have multiple transmission time slots, and a transmission queue, i.e., time-division switch transmission queue, is set up for every time slot for the convenience in management and scheduling. When corresponding forwarding table entry has been obtained, the received Ethernet frame of fixed length is sent to the time-division switch transmission queue in corresponding time slot at corresponding Ethernet port.

The switching is explained with reference to examples in the following description. Table 2 shows a forwarding table for switching based on destination MAC address in Embodiment 1 of the present invention. The forwarding table has n entries, wherein n>1.

TABLE 2

| | | | | | |
|---|---|---|---|---|---|
| Entry | Destination MAC | Other | → | To the time-division switch | Other |
| 1 | Address a1 | attributes | | transmission queue in Time | action |
| | | | | Slot 1 at Ethernet Port 3 | |
| Entry | Destination MAC | Other | → | To the time-division switch | Other |
| 2 | Address b1 | attributes | | transmission queue in Time | action |
| | | | | Slot 6 at Ethernet Port 1 | |
| Entry | Destination MAC | Other | → | To the time-division switch | Other |
| 3 | Address c1 | attributes | | transmission queue in Time | action |
| | | | | Slot 2 at Ethernet Port 3 | |
| Entry | Destination MAC | Other | → | To the time-division switch | Other |
| 4 | Address d1 | attributes | | transmission queue in Time | action |
| | | | | Slot 2 at Ethernet Port 1 | |

. . .

| | | | | | |
|---|---|---|---|---|---|
| Entry | Destination MAC | Other | → | To the time-division switch | Other |
| N | Address n1 | attributes | | transmission queue in Time | action |
| | | | | Slot q at Ethernet Port p | |

The forwarding table shown in Table 2, like the forwarding table of the conventional Ethernet switch shown in Table 1, includes two parts: the attributes of the Ethernet frames of fixed length, e.g., the destination MAC addresses, and the action to be taken with the Ethernet frames that have the attribute(s). In this embodiment, the attributes “destination MAC addresses” are linked with actions “forward to the time-division switch transmission queue in Time Slot X at Ethernet Port Y” to form the relations that support the forwarding process. In multicast, an Ethernet frame can be forwarded to the time-division switch transmission queues in multiple transmission time slots at multiple Ethernet ports, hence the relations that support the forwarding process are one to multiple relations.

The contents of the entries in the L2/L3 forwarding table can be defined one by one manually or be defined dynamically by using Generalized Multi-Protocol Label Switching (GMPLS) in a system supporting GMPLS, as a result every transmission time slot at the transmitting component of every Ethernet port is associated with a specific MAC address, or a specific IP address, or specific L2/L3 information.

An Ethernet frame can be modified by using “other action” in Table 2 before being switched to a transmission queue in a time slot.

The relations in the forwarding table are set up according to external configuration information, which may come from the network administrator.

It should be noted that the forwarding table entries in Table 2 will not be updated in the automatic learning and aging of the MAC addresses during the period between setting up a time-division link and disconnecting the time-division link.

The basic principle of time-division switching shown in Table 2 is explained hereinafter.

FIG. 5 is the schematic diagram of the Ethernet synchronized time-division switching in Embodiment 1 of the present invention. As shown in FIG. 5, every Ethernet port has 8 time slots. The squares with letters indicate time slots carrying Ethernet frames of fixed length, and the letters indicate the destination MAC addresses of the Ethernet frames of fixed length. FIG. 5 only shows the destination MAC addresses of a part of the Ethernet frames of fixed length for the clarity in showing the situations before switching and after switching.

For example, the switching of an Ethernet frame with the destination MAC address a1 received by the receiving component of the Ethernet Port 1 includes: obtaining the destination MAC address a1 from the Ethernet frame of fixed length, finding matched forwarding table entry, i.e., Entry 1, in Table 2, and switching the Ethernet frame of fixed length to the time-division switch transmission queue in Time Slot 1 at Ethernet Port 3 based on the relation recorded in the Entry 1; similarly, the Ethernet frames of fixed length received by the receiving components of the Ethernet ports are switched based on the entries in Table 2 so that the time-division switching of the Ethernet frames of fixed length is achieved.

The switching process in this step is executed repeatedly, hence there is no strict order in performing the following Steps 304 and 305.

Step 304: Judge whether the intermittent transmission of the transmission time slot can be started; when the transmission interval expires, go to Step 305, otherwise repeat Step 304.

In this step, the judgment of whether the trans mission interval of the transmission time slot expires is made based on the length of the Ethernet frame of fixed length, the number of the transmission time slots and the clock period of local clock of the Ethernet port.

To be specific, the transmission time of the Ethernet frame of fixed length is first calculated based on the length of the Ethernet frame of fixed length and the clock period of the Ethernet port. The transmission time of the Ethernet frame of fixed length=byte number of the Ethernet frame of fixed length X the time needed for the transmission of a byte. In an Ethernet of 10 Mbps, the time needed to transmit an Ethernet frame of a fixed length of 625 bytes=625×(0.1×8)=500 μs.

After that, the transmission interval of a time slot is obtained by multiplying the time needed to transmit an Ethernet frame of fixed length by the number of the time slots. For example, the Ethernet port has 10 transmission time slots, the transmission interval of a transmission time slot is 10×500 μs=5 ms. Hence a transmission time slot transmits an Ethernet frame of fixed length every 5 ms.

Lastly, the transmission interval is timed from the start of the transmission of the slot. The time difference between the starts of two transmission slots equals the time needed to transmit an Ethernet frame of fixed length, e.g., 500 μs.

Step 305: the Ethernet port transmits the Ethernet frame of fixed length in the time slot whose transmission interval expires.

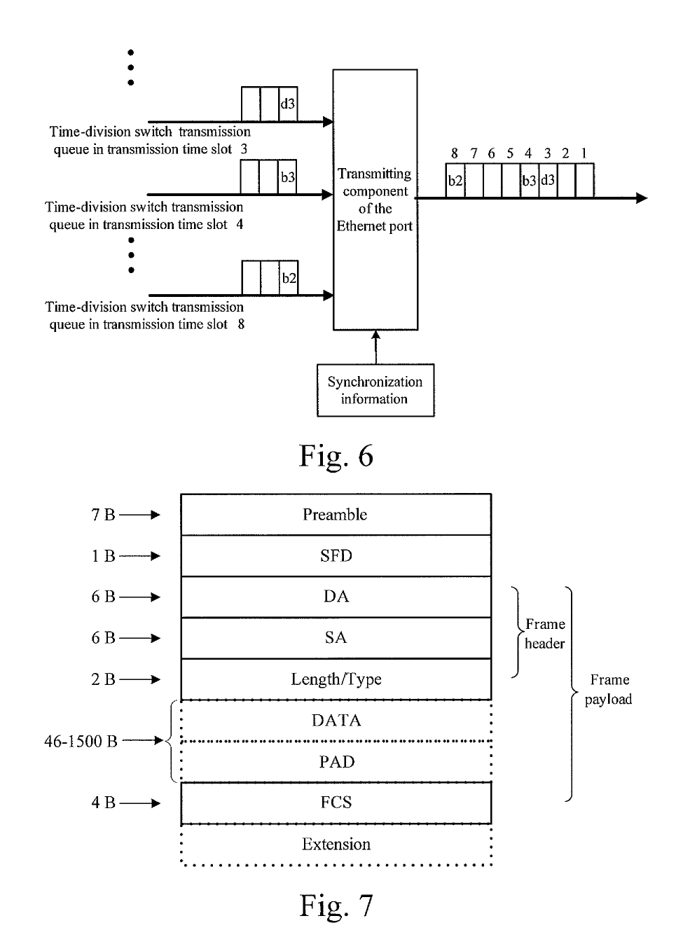

In the process of transmitting Ethernet frames of fixed length, the Ethernet frames of fixed length in the time-division switch transmission queue of the transmission time slot are read and transmitted according to the order of the queue. FIG. 6 is a schematic diagram illustrating the time-division switch transmission queue at the transmitting component of an Ethernet port in an embodiment of the present invention. As shown in FIG. 6, when the present transmitting time slot is Time Slot 3, the first Ethernet frame in the time-division switch transmission queue of Time Slot 3 shall be read. FIG. 6 shows only the transmission queues of Time Slots 3, 4 and 8.

The combination of Steps 304 and 305 achieves cyclic transmission of the to-be-transmitted Ethernet frames of fixed length in the time-division switch transmission queues maintained in the time slots.

The judgment made in Step 304 on whether the transmission interval expires and the transmission of Ethernet frames of fixed length in Step 305 are executed based on local clock. In order to ensure accurate switching of the received Ethernet frames of fixed length by an Ethernet port, the local clock of the Ethernet port has to be synchronized with the clocks of upstream and downstream equipments, and the synchronization can be achieved by adjusting the local clock based on acquired synchronization information.

At present many methods can be used in the Ethernet system to provide synchronization information, e.g., a first method may include extracting the clock of upstream lines as the synchronization information and sending the synchronized local clock to the downstream equipment of the Ethernet switch as the synchronization information; a second method may include calculating the transmitting time and the receiving time of an Ethernet frame of fixed length to obtain the synchronization information, such as in IEEE 1588 or IEEE 802.1as; a third method may include obtaining synchronization information from the synchronization system of the Global Positioning System (GPS); and a fourth method may include obtaining synchronization information from a synchronization network on the Plesiochronous Digital Hierarchy (PDH) or Synchronous Digital Hierarchy (SDH).

The Ethernet switching in this embodiment ends here.

Since the length of the Ethernet frames is fixed and the Ethernet frames of fixed length carrying the same service stream are transmitted regularly through a time slot, the transmission delay of an Ethernet frame of fixed length is fixed and independent of the influence of other time slots; furthermore the Ethernet frames are transmitted regularly so that the Ethernet port with time-division multiplexing applied may transmit time-division services at constant rate by transmitting Ethernet frames of fixed length.

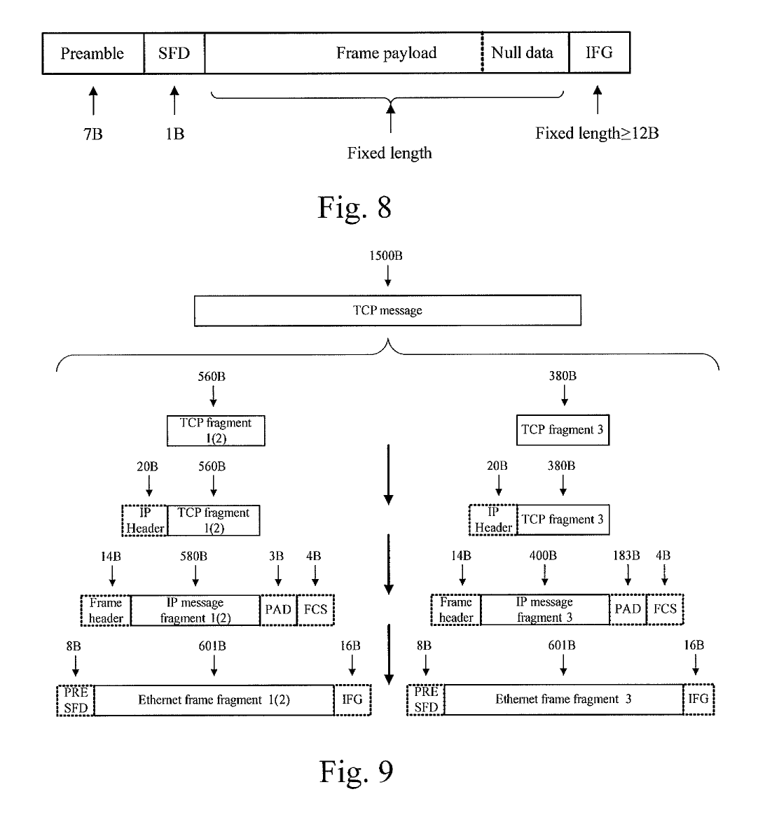

An Ethernet frame of fixed length is explained hereinafter with reference to FIGS. 7 and 8, and the construction of the Ethernet frame in the preceding Step 300 is further explained in detail.

FIG. 7 is a schematic illustrating the structure of an Ethernet frame in accordance with the present IEEE802.3. As shown in FIG. 7, the Ethernet frame includes: preamble of 7 bytes, Start Frame Delimiter (SFD) of 1 byte, Frame payload of undefined number of bytes and an extension field. The Frame payload of the Ethernet frame includes frame header of 14 bytes, data field of 46-1500 bytes, pad field and Frame Check Sequence (FCS) of 4 bytes, wherein the frame header of 14 bytes further includes Destination Address (DA) of 6 bytes, Source Address (SA) of 6 bytes and Length/Type of 2 bytes. The Ethernet frame shall includes the pad field and/or the extension field only when the length of the Ethernet frame is shorter than the minimum length allowed by the carrier, and the pad field and the extension field is adapted to extend the length of the Ethernet frame to the minimum frame length and the minimum length allowed by the carrier. IEEE 802.3 further defines that the Inter Frame Gap (IFG) at a port of 10 Mbps, 100 Mbps or 1000 Mbps shall occupy at least 12 bytes (not shown in FIG. 7).

FIG. 8 is a schematic illustrating the structure of an Ethernet frame of fixed length in accordance with the present invention. As shown in FIG. 8, an Ethernet frame of fixed length constructed in accordance with the present invention is compatible with the present Ethernet frame described above, i.e., the Ethernet frame of fixed length in the present invention still includes preamble of 7 bytes, SFD of 1 byte and IFG larger than or equal to 12 bytes, however, the Frame payload of the Ethernet frame of fixed length in the present invention includes fixed amount of data, i.e., has fixed Frame payload length. For example, when the preamble occupies 7 bytes, the SFD occupies 1 byte, the Frame payload occupies 601 bytes and the IFG occupies 16 bytes, the length of the whole Ethernet frame shall be 625 bytes, i.e., the fixed length of the Ethernet frame. At an Ethernet port of 10 Mbps, the transmission time of a frame of 625 bytes equals: ( 1/10) μs×8 clock periods×625 bytes=500 μs; and at an Ethernet port of 100 Mbps, the transmission time of a frame of 625 bytes equals 50 μs.

The Frame payload of an Ethernet frame of fixed length carries the frame payload corresponding to the to-be-transmitted upper layer data, the frame payload of the to-be-transmitted upper layer data is the data encapsulated by L2/L3, including data payload, frame header and FCS.

When the length of the frame payload corresponding to the to-be-transmitted upper layer data is equal to the fixed length of the Frame payload of the Ethernet frame of fixed length, the format of the data can be converted directly to produce corresponding Ethernet frame of fixed length. The format conversion includes adding the preamble, SFD and IFG to the frame payload corresponding to the to-be-transmitted upper layer data to produce the Ethernet frame of fixed length.

When the length of the frame payload corresponding to the to-be-transmitted upper layer data is shorter than the fixed length of the Frame payload of the Ethernet frame of fixed length, the format of the data shall be converted with null data filling the space between the Frame payload and the IFG to produce the Ethernet frame of fixed length. The filled null data may constitute an extension field or be a part of the IFG. When the filled null data shall be the IFG data, the null data shall be filled by keeping the line idle for a specific period of time without transmitting any data. The null data can also be the pad field to fill the extra space between the data field and the FCS field in the Frame payload. It is comparatively simple to fill the null data as a part of the IFG, i.e., the to-be-transmitted Ethernet frame can be transmitted directly when the transmission interval expires as long as the length of the Ethernet frame is shorter than or equal to the fixed length of the Ethernet, the Ethernet frame of fixed length is produced by keeping the line idle after the Ethernet frame has been transmitted and before the start of the next transmission slot.

When the length of the frame payload corresponding to the to-be-transmitted upper layer data is longer than the fixed length of the Frame payload of the Ethernet frame of fixed length, the upper layer data shall be fragmented by using a fragmenting method and the format of the fragments obtained shall be converted to produce Ethernet frames of fixed length, i.e., the data shall be transmitted across multiple Ethernet frames.

Many fragmenting methods may be adopted, such as the IP packet fragmenting or MAC frame fragmenting. The construction of Ethernet frames through IP packet fragmenting is described in detail hereinafter.

In the present invention, a TCP message can be fragmented by using IP packet fragmenting method to produce TCP fragments; the TCP fragments are further encapsulated to produce Ethernet frames in accordance with the present invention. The process includes the following 4 steps.

1. Determine the number n of the fragments to be obtained.

In this step, the fixed length of the Frame payload in the Ethernet frame of fixed length and the length of the TCP message to be fragmented shall be determined first. The maximum length of the IP message fragment allowed in an Ethernet frame fragment is obtained by taking 14 bytes of frame header and 4 bytes of FCS out of the fixed length of the Frame payload. Since an IP message fragment consists of an IP header and a TCP fragment, 20 bytes of IP header shall also be taken out of the fixed length of the Frame payload to obtain the maximum length of the TCP fragment allowed in an Ethernet frame fragment. An integer smaller than or equal to the maximum length of the TCP fragment shall be chosen as the actual length of the TCP fragment, and the length of the IP message fragment, i.e., the sum of the actual length of the TCP fragment and the length of the IP header, shall be a multiple of 8 bytes. After that, divide the total length of the TCP message to be fragmented by the actual length of the TCP fragment. When the quotient is an integer, the integer quotient shall be the number of fragments to be obtained, i.e., the number n; or, when the quotient is not an integer, the number n of the fragments to be obtained shall be the rounded quotient plus 1. The formula to be used is: round (the length of the TCP message to be fragmented/the actual length of the TCP fragment), wherein the actual length of the TCP fragment is an integer equal to or smaller than the maximum length of the TCP fragment (=fixed length of the Frame payload−length of the frame header−length of the FCS−length of the IP header); and the rounding includes rounding the quotient when the quotient is not an integer and adding 1 to the result of the rounding.

An example is given herein. FIG. 9 is a schematic illustrating the construction of an Ethernet frame of fixed length by using IP packet fragment in this embodiment. As shown in FIG. 9, the length of the TCP message is 1500 bytes, the fixed length of the Frame payload is 601 bytes and the IFG is 16 bytes. When the normal Ethernet frame structure shown in FIG. 7 is adopted, the length of the Frame payload shall be 1500+20+6+6+2+4=1538 bytes, which is much longer than the fixed length 601 bytes of the Frame payload, hence the message shall be fragmented by using the IP packet fragmenting method.

The fixed length of the Frame payload in the Ethernet frame of fixed length is 601 bytes, hence the maximum bytes allowed in the TCP message fragment to be carried in an Ethernet frame fragment is 601−14−4−20=563 bytes. In this embodiment, the actual length of the TCP fragment is 560, hence the number n of the fragments to be obtained equals the rounded result of 1500/560 plus 1, i.e., 3.

2. Divide the TCP message into n fragments and find out the length of each of the TCP fragments.

In this step, the length of the first (n−1) TCP fragments equals the actual length of the TCP fragment. The length of the n^{th} TCP fragment equals the total length of the first (n−1) TCP fragments subtracted from the length of the TCP message.

Concerning the TCP message shown in FIG. 9, the number of the fragments is 3, the length of each of the TCP fragment 1 and TCP fragment 2 is 560 bytes and the length of the TCP fragment 3 is 1500−2×560=380 bytes.

3. Construct Ethernet frame fragments based on the TCP fragments.

In this step, an IP header of 20 bytes, frame header of 14 bytes and FCS of 4 bytes are added to each of the TCP fragments and null bytes are used to make up for the unfilled part of the fixed length of the Frame payload.

Concerning the TCP message shown in FIG. 9, the length of the TCP fragment 1 or 2 plus the IP header, the frame header and the FCS shall be 560+20+14+4=598 bytes, hence 601−598=3 bytes of null data are used to make up for the unfilled part of the fixed length of the Frame payload, in this way Ethernet frame fragment 1 of fixed 601 bytes and Ethernet frame fragment 2 of fixed 601 bytes are produced. The total length of the TCP fragment 3 plus the IP header, the frame header and the FCS is 380+20+14+4=418 bytes, hence 601−418=183 bytes of null data are used to make up for the unfilled part of the fixed length of the Frame payload and produce the Ethernet frame fragment 3 of fixed 601 bytes. In this fragment the null data are filled as the pad field.

4. Construct Ethernet frames of fixed length.

In this step, a preamble of 7 bytes, SFD of 1 byte and IFG of fixed number of bytes are added to each of the Ethernet frame fragments of fixed length to construct Ethernet frames of fixed length.

Concerning the TCP message shown in FIG. 9, a preamble, SFD and IFG are added to each of the Ethernet frame fragments 1, 2 and 3 of a fixed length of 601 bytes to produce Ethernet frames of a fixed length of 601+7+1+16=625 bytes.

The IP packet fragmenting process is thus completed.

It can also be seen from FIG. 9 that each of the Ethernet frame fragments carrying the IP message fragments carries complete L2 information and L3 information. The L2 information includes the frame header of 14 bytes in each of the Ethernet frame fragments and the L3 information includes the IP header of 20 bytes in each of the IP message fragments, wherein the IP header carries detailed IP message fragment information. The device that gets the IP message fragments may reconstruct the IP message according to the order recorded in the IP message fragment information.

The present invention also provides another fragmenting method, i.e., MAC frame fragmenting. The construction of an Ethernet frame through MAC frame fragmenting is described in detail hereinafter.

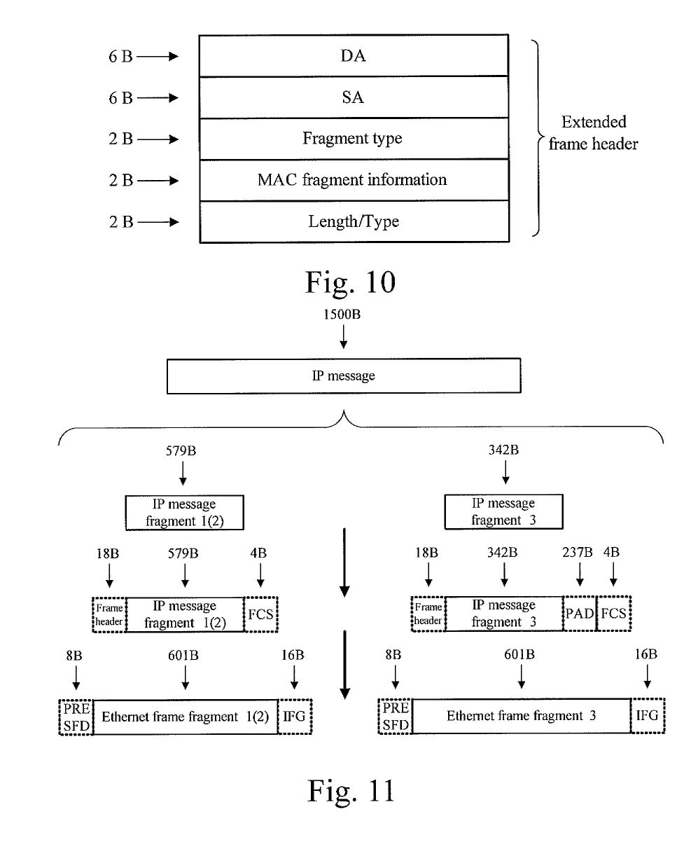

According to the MAC frame fragmenting method, the IP message is fragmented directly to obtain IP message fragments, and the IP message fragments are encapsulated to produce the Ethernet frames in accordance with the present invention. It should be noted that, since IP header is added to each of the TCP messages in the IP packet fragmenting, IP header may include the IP fragment information. However, in the MAC frame fragmenting, an IP message is fragmented directly and the MAC fragment information cannot be expressed in the IP header, so the present invention extends the frame header which includes the L2 information so that the MAC fragment information can be added into the frame header. FIG. 10 illustrates the structure of the extended frame header. As shown in FIG. 10, 2 bytes are added into the extended frame header to indicate the fragment type, i.e., to indicate whether the Ethernet frame is a fragment; in the MAC fragment information of 2 bytes, 1 bit, the location of which can be customized, indicates whether the Ethernet frame is the last fragment, and the rest 15 bits indicate the deviation amount. So the length of the extended frame header shall be 15 bytes.

The process includes the following 4 steps.

1. Determine the number m of the fragments to be obtained.

In this step, the fixed length of the Frame payload in the Ethernet frame of fixed length and the length of the IP message to be fragmented shall be determined first. The maximum length of the IP message fragment allowed in an Ethernet frame fragment is obtained by taking 18 bytes of extended frame header and 4 bytes of FCS out of the fixed length of the Frame payload. An integer smaller than or equal to the maximum length of the IP message fragment shall be chosen as the actual length of the IP message fragment. After that, divide the total length of the IP message to be fragmented by the actual length of the IP fragment. When the quotient is an integer, the integer quotient shall be the number of fragments obtained, i.e., the number m; or, when the quotient is not an integer, the number m of fragments obtained shall be the rounded quotient plus 1. The formula to be used is: round (the length of the IP message to be fragmented/the actual length of the IP fragment), wherein the actual length of the IP fragment is an integer equal to or smaller than the maximum length of the IP fragment (=fixed length of the Frame payload−length of the extended frame header−length of the FCS); and the rounding includes rounding the quotient when the quotient is not an integer and adding 1 to the result of the rounding.

An example is given herein. FIG. 11 is a schematic illustrating the construction of an Ethernet frame of fixed length by using MAC frame fragment in this embodiment. As shown in FIG. 11, the length of the IP message is 1500 bytes. When the conventional Ethernet frame structure shown in FIG. 7 is adopted, the length of the Frame payload shall be 1500+6+6+2+4=1518 bytes, which is much longer than the fixed length of 601 bytes, hence the message shall be fragmenting by using the MAC frame fragmenting method.

In this embodiment, the fixed length of the Frame payload in the Ethernet frame of fixed length is 601 bytes, so the maximum number of bytes of the IP message fragment allowed in the Ethernet frame fragment is 601−18−4=579 bytes. In this embodiment, the actual length of the IP message fragment is 579, hence the number m of the fragments to be obtained equals the rounded result of 1500/579 plus 1, i.e., 3.

2. Divide the IP message into m fragments and find out the length of each of the IP message fragments.

In the process, the length of the first (m−1) IP message fragments equals the actual length of the IP message fragment. The length of the m^{th} IP fragment equals the total length of the first (m−1) IP fragments subtracted from the length of the IP message.

Concerning the IP message shown in FIG. 11, the number of the fragments is 3, the length of each of the IP message fragment 1 and IP message fragment 2 is 579 bytes and the length of the IP message fragment 3 is 1500−2×579=342 bytes.

3. Construct Ethernet frame fragments based on the IP message fragments.

In this step, an extended frame header of 18 bytes and FCS of 4 bytes are added to each of the IP fragments and null bytes are used to make up for unfilled part the fixed length of the Frame payload.

Concerning the IP message shown in FIG. 11, the length of IP message fragment 1 or 2 plus the extended frame header and the FCS is 579+18+4=601 bytes and the Ethernet frame fragments 1 and 2 of a fixed length of 601 bytes are thus produced, no null data is needed in these two frames. The total length of the IP message fragment 3 plus the extended frame header and the FCS is 342+18+4=364 bytes, hence 601−364=237 bytes of null data are used to make up for the unfilled part of the fixed length of the Frame payload and produce the Ethernet frame fragment 3 of fixed 601 bytes. In this fragment the null data are filled as the pad field.

4. Construct Ethernet frames of fixed length.

In this step, a preamble of 7 bytes, SFD of 1 byte and IFG of fixed number of bytes are added to each of the Ethernet frame fragments to construct Ethernet frames of fixed length.

Concerning the IP message shown in FIG. 11, a preamble, SFD and IFG are added to each of the Ethernet frame fragments 1, 2 and 3 of a fixed length of 601 bytes to produce Ethernet frames of a fixed length of 601+7+1+16=625 bytes.

The MAC frame fragmenting process is thus completed.

It can also be seen from FIG. 11 that each of the Ethernet frame fragments carrying the IP message fragments carries complete L2 information. The L2 information is the extended frame header of 18 bytes, including the detailed MAC fragment information. The device that gets the MAC frame fragments may reconstruct the IP message according to the order recorded in the MAC fragment information.

The preceding description is the detailed process of constructing Ethernet frame of fixed length in Step 300.

### Embodiment 2

In this embodiment, an Ethernet switching method combining the time-division switching and the packet switching is illustrated.

In practical applications, the transmission time slots at an Ethernet port can be configured to designate some transmission time slots as time-division switching time slots for time-division services in time-division switching, and the rest transmission time slots shall carry burst service streams in the packet switching, hence the transmission time slots at the Ethernet port are not all dedicated to the time-division service streams transmitted at constant rate.

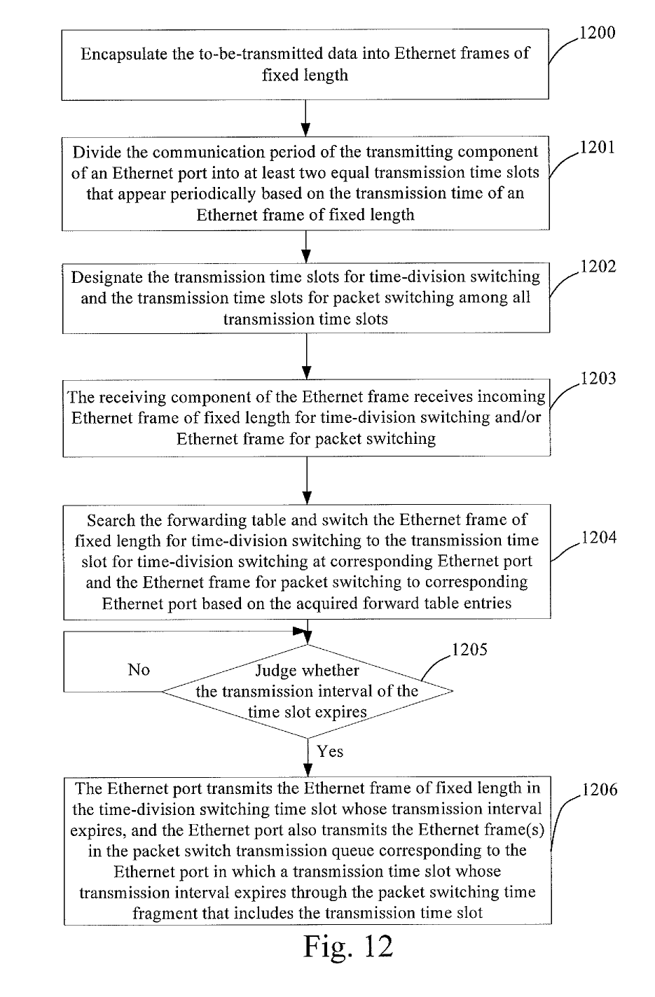

FIG. 12 is a flow chart of the Ethernet switching method in Embodiment 2 of the present invention. As shown in FIG. 12, the method includes the following steps.

Step 1200: the to-be-transmitted upper layer data are encapsulated into Ethernet frames of fixed length.

The format and encapsulation method of the Ethernet frames of fixed length are identical with the format and encapsulation method described in Embodiment 1.

Step 1201: divide the communication period of the transmitting component of an Ethernet port into at least two equal transmission time slots that appear periodically with the transmission time of an Ethernet frame of fixed length as the basic time unit.

The method for dividing the communication period into the transmission time slots is identical with the method described in Step 301 of FIG. 3.

Step 1202: among all transmission time slots, some transmission time slots are designated as the time slots for time-division switching and other transmission time slots are designated as the time slots for packet switching.

In this step, it may also be acceptable to designate the transmission time slots of time-division switching only, and the rest transmission time slots that are not in the time-division switching are regarded by default as the time slots for conventional Ethernet packet switching. The time slots for time-division switching carry service streams transmitted at constant rate and the time slots that are not in the time-division switching, i.e., the packet switching time fragment, carry burst service streams.

In practical applications, the packet switching time fragment includes at least one transmission time slot. The length of an Ethernet frame in the packet switching may be too long to be carried in one time slot, hence two or more than two consecutive transmission time slots may be designated as the time slots for packet switching, and the consecutive time slots in the packet switching can constitute a long packet switching time fragment. The packet switching time fragment can carry one or more than one conventional Ethernet frame. The number of conventional Ethernet frames to be carried in the packet switching time fragment is decided based on the length of the packet switching time fragment and the length of the to-be-transmitted Ethernet frames.

In this step, the time slots configured as the time slots for time-division switching and the time slots for packet switching are decided flexibly and the configuration can be changed according to practical needs.

Step 1203: the receiving components of the Ethernet ports receive incoming Ethernet frames of fixed length for time-division switching and/or Ethernet frames for packet switching.

Step 1204: search the forwarding table based on the L2/L3 information of the received Ethernet frames of fixed length for time-division switching and/or Ethernet frames for packet switching to find forwarding table entries corresponding to the Ethernet frames of fixed length for time-division switching and/or Ethernet frames for packet switching, switch the received Ethernet frames of fixed length for time-division switching into corresponding time-division switching time slots at corresponding Ethernet ports according to the found table entries, and switch the received Ethernet frames for packet switching into corresponding Ethernet ports according to the found table entries.

The forwarding table in this embodiment saves relations between the L2/L3 information for time-division switching and the time slots at the Ethernet ports and the relations between the L2/L3 information for packet switching and the transmission queues at specified Ethernet ports.

The time-division switching time slots at the Ethernet ports maintain transmission queues separately, i.e., the time-division switch transmission queues; while different packet switching time fragments at one Ethernet port correspond to one transmission queue, i.e., a packet switch transmission queue; or, an Ethernet port may have two packet switch transmission queues of different priority levels which have no certain relations with the packet switching time fragments at the Ethernet port.

An example is given hereinafter to illustrate the switching process in accordance with the present invention. Table 3 shows a forwarding table for destination MAC address based time-division switching and packet switching in Embodiment 2 of the present invention.

TABLE 3

| | | | | | |
|---|---|---|---|---|---|
| Entry | Destination MAC | Other | → | To the time-division switch | Other |
| 1 | Address a1 | attributes | | transmission queue in | action |
| | | | | time-division switching time | |
| | | | | slot 1 at Ethernet Port 3 | |
| Entry | Destination MAC | Other | → | To the time-division switch | Other |
| 2 | Address b1 | attributes | | transmission queue in | action |
| | | | | time-division switching time | |
| | | | | slot 6 at Ethernet Port 1 | |

. . .

| | | | | | |
|---|---|---|---|---|---|
| Entry | Destination MAC | Other | → | To the time-division switch | Other |
| m | Address m1 | attributes | | transmission queue in | action |
| | | | | time-division switching time | |
| | | | | slot q at Ethernet Port p | |
| Entry | Destination MAC | Other | → | To the packet switch | Other |
| m + 1 | Address p1 | attributes | | transmission queue 1 at the | action |
| | | | | Ethernet Port 1 | |

. . .

| | | | | | |
|---|---|---|---|---|---|
| Entry | Destination MAC | Other | → | To the packet switch | Other |
| n | Address p4 | attributes | | transmission queue 4 at the | action |
| | | | | Ethernet Port 2 | |

As shown in Table 3, the forwarding table has n entries, wherein n>1; the first m entries are used for switching Ethernet frames of fixed length in the time-division switching, i.e., for providing specified Ethernet ports and specified transmission time slots based on the destination MAC address of the Ethernet frames of fixed length in the time-division switching.

The m+1^{th} to n^{th} entries are used for transmitting Ethernet frames in the packet switching, i.e., for providing specified Ethernet frames based on the destination MAC address of the Ethernet frames in the packet switching, wherein n>1, m>1 and n>m.

Like the forwarding table shown in Table 2, the forwarding table shown in Table 3 also includes two parts: the attributes of the data frames/packets, e.g., the destination MAC addresses, and the action to be taken with the data frames/packets that have the attribute(s), e.g., forward to the time-division switch transmission queue in a specified time-division transmission time slot at a specified Ethernet port, or forward to a packet switch transmission queue at a specified Ethernet port, or forward to time-division switch transmission queues in multiple time-division switching time slots at multiple Ethernet ports in multicast, or forward to packet switch transmission queues at multiple Ethernet ports in multicast.

It should be noted that, the first m entries for time-division switching in Table 3 support static configuration and will not be updated by automatic MAC learning and aging from the setting up of corresponding time-division link till the disconnection of the time-division links; the m+1^{th} to n^{th} entries for packet switching supports both automatic MAC learning and aging and static configuration, just like the forwarding table entries of normal conventional Ethernet switches.

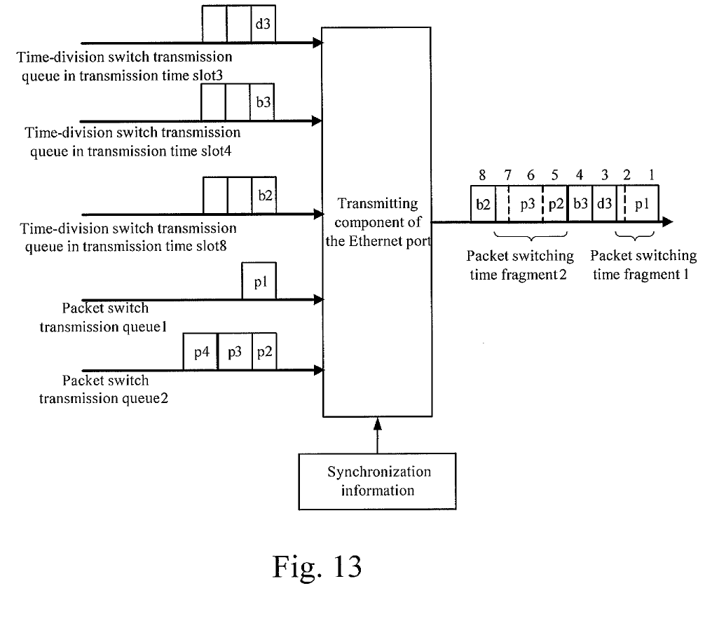

FIG. 13 is a schematic illustrating the transmission queue at the transmitting component of an Ethernet port in Embodiment 2 of the present invention. As shown in FIG. 13, the transmitting component of the Ethernet port has 3 time-division switch transmission queues in three time-division switching time slots and two packet switch transmission queues of different priority levels.

Step 1205: judge whether the intermittent transmission of the transmission time slot can be started; when the interval expires, go to Step 1206, otherwise repeat Step 1205.

Step 1206: the Ethernet port transmits the Ethernet frame of fixed length in the time-division switching time slot whose transmission interval expires, and the Ethernet port also transmits the Ethernet frame(s) in the packet switch transmission queue corresponding to the Ethernet port in which a transmission time slot whose transmission interval expires through the packet switching time fragment that includes the transmission time slot.

The Ethernet switching in this embodiment ends here.

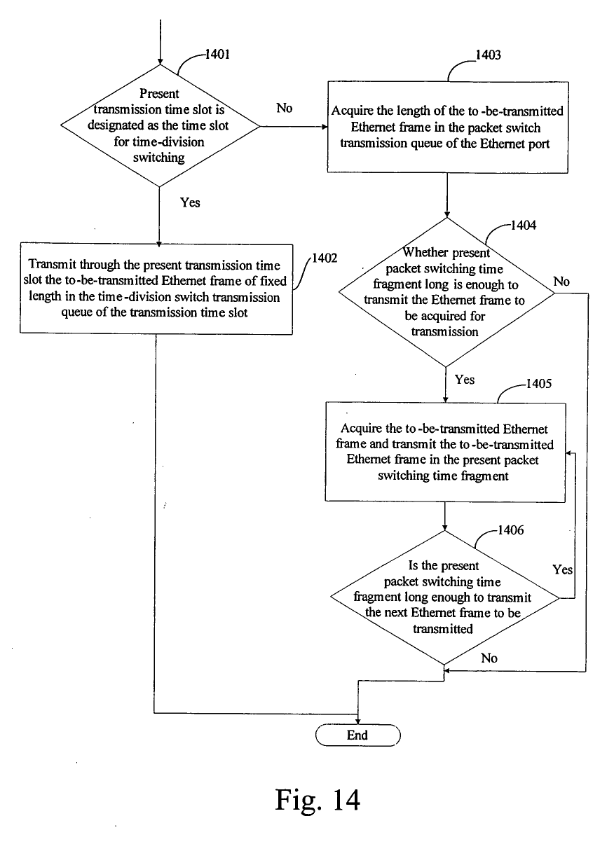

FIG. 14 is a flow chart of transmitting Ethernet frames of fixed length/Ethernet frames in Step 1206 of FIG. 12. This flow only shows the transmission process of one transmission time slot, and the other transmission time slots all adopt the same transmission process. As shown in FIG. 14, the method includes the following steps.

Step 1401: judge whether the present transmission time slot is designated as a time slot in the time-division switching, if so, go to Step 1402, otherwise go to Step 1403.

The present transmission time slot is the time slot whose transmission interval just expired.

Step 1402: transmit, through the present time slot, the to-be-transmitted Ethernet frame of fixed length in the time-division switch transmission queue of the present transmission time slot. The process ends here.

Step 1403: acquire the length of the to-be-transmitted Ethernet frame in the packet switch transmission queue at the Ethernet port.

In this step, the to-be-transmitted Ethernet frame in the packet switch transmission queue is acquired according to a priority policy. The priority policy is usually set up before the switching and the simplest policy is to arrange the Ethernet frames according to the priority levels of the Ethernet frames.

Step 1404: judge, based on the length of the to-be-transmitted Ethernet frame, whether the Ethernet frame to be transmitted can be transmitted through the packet switching time fragment that includes the present transmission time slot, if the Ethernet frame can be transmitted, go to Step 1405, otherwise terminate the process.

The Ethernet frame that cannot be transmitted may be transmitted through another packet switching time fragment. When the Ethernet is unable to be transmitted through any of the packet switching time fragments, the Ethernet frame shall be discarded. When the transmission time slots for time-division switching are designated, normally enough length shall be left for conventional Ethernet frames in the packet switching time fragments so that the packet switching time fragment may carry long Ethernet frames.

In Step 1404, the judgment is made by calculating the length of the time between the present and starting time of the next time-division switch transmission time slot designated for the time-division switching, i.e., the length of the packet switching time fragment that includes the present transmission time slot, judging whether the length of the time is longer than or equal to the transmission time needed for the to-be-transmitted Ethernet frame, deciding that the Ethernet frame can be transmitted if the length of the time is longer than or equal to the transmission time needed for the Ethernet frame, otherwise deciding that the Ethernet frame cannot be transmitted.

Step 1405: acquire the to-be-transmitted Ethernet frame and transmit the Ethernet frame in the present packet switching time fragment.

Step 1406: judge whether the next Ethernet frame to be transmitted in the packet switch transmission queue at the present Ethernet port can be transmitted in the remaining time of the packet switching time fragment, go to Step 1405 if the next Ethernet frame can be transmitted, otherwise terminate the process.

The judgment in this step is made by: calculating the length of the time between the present and starting time of the next time-division switch transmission time slot designated for the time-division switching, i.e., the length of the remaining time of the packet switching time fragment, judging whether the length of the time is longer than or equal to the transmission time needed for the next to-be-transmitted Ethernet frame, deciding that the next Ethernet frame can be transmitted if the length of the time is longer than or equal to the transmission time needed for the next Ethernet frame, otherwise deciding that the next Ethernet frame cannot be transmitted. The process ends here.

In the transmission queue at the transmitting component of the Ethernet port shown in FIG. 13, the communication time of the transmitting component of the Ethernet port is divided into 8 time slots, the 3^{rd}, 4^{th} and 8^{th} time slots are designated as the time slots for time-division switching; among the remaining undesignated 1^{st}, 2^{nd}, 5^{th}, 6^{th} and 7^{th} time slots, the 1^{st} and the 2^{nd} time slots constitute the packet switching time fragment 1 of 2 time slots, and the 5^{th}, 6^{th} and 7^{th} time slots constitutes the packet switching time fragment 2 of 3 time slots. The Ethernet frames of packet switching are transmitted in the packet switching time fragments. The Ethernet port maintains 3 time-division switch transmission queues in the 3 time-division switching time slots as well as 2 packet switch transmission queues of different priority levels. The data in the time-division switch transmission queues and the packet switch transmission queues after the switching in Step 1204 are shown in FIG. 13. During the transmission of the Ethernet, the time slots from the 1^{st} to the 8^{th} are processed according to the numeric order. Since the 1^{st}, 2^{nd}, 5^{th}, 6^{th} and 7^{th} time slots are not designated as the time slots for time-division switching, during the packet switching time fragment 1 which includes the 1^{st} and 2^{nd} time slots, the length of the Ethernet frame with the destination address p1 in the packet switch transmission queue 1 of higher priority shall be acquired first, when it is judged that the length of the Ethernet frame is shorter than the length of the packet switching time fragment 1, the Ethernet frame with the destination address p1 shall be transmitted; after that, the Ethernet frame with the destination address p2 in the packet switch transmission queue 2 of the second highest priority shall be acquired, and it shall be judged whether the length of the Ethernet frame is longer than the remaining time length of the packet switching time fragment 1, if so, the data cannot be transmitted and the port is left idle till the 3^{rd} transmission time slot. In the packet switching time fragment 2 which includes the 5^{th}, 6^{th} and 7^{th} time slots, the packet switch transmission queue 1 contains no data and the length of the Ethernet frame with the destination address p2 in the packet switch transmission queue 2 is acquired, when it is judged that the length of the Ethernet frame is shorter than the length of the packet switching time fragment 2, the Ethernet frame with the destination address p2 shall be transmitted; after that, the next Ethernet frame with the destination address p3 in the packet switch transmission queue 2 shall be acquired, when it is judged that the length of the Ethernet frame is shorter than the length of the remaining time of the packet switching time fragment 2, the Ethernet frame with the destination address p3 shall be transmitted, then it is judged whether the remaining time of the packet switching time fragment is enough to transmit the Ethernet frame with the destination address p4, if the remaining time is not enough, the data shall not be transmitted and the port is left idle till the 8^{th} time slot. And as long as the 3^{rd}, 4^{th} and 8^{th} time slots are designated as the time slots for time-division switching, the Ethernet frames of fixed length shall be acquired from the time-division switch transmission queues in the time slots according to the serial numbers of the time slots and the Ethernet frames of fixed length shall be transmitted through corresponding time slots.

The process ends here.

In the preceding embodiments, all the transmission queues obey the FIFO principle. In practical applications, the rate of the time-division service data transmission may be lower than the bandwidth of a time-division switching time slot, so the Ethernet frames of fixed length carrying the service stream may be transmitted at intervals instead of continuously. For example, between the transmissions of two Ethernet frames of fixed length time-division service, an idle time fragment of the same length as the Ethernet frames may be transmitted. When a time-division service stream carried in a transmission time slot occupies only a part of the bandwidth of the time slot, the service stream is called a sub-slot-rate time-division service. Therefore, in the same time-division switching time slot, when no Ethernet frame of fixed length is received, an idle time fragment shall be transmitted. In order to support time slot sub-rate time-division services, the time-division switch transmission queues maintained by the transmitting components of the Ethernet ports are not simply FIFO queues, the parts without Ethernet frames of fixed length in the time-division switch transmission queues are identified as idle time fragments. However, in a time-division switch transmission queue, the buffered Ethernet frames of fixed length and idle time fragments still obey the FIFO principle. When the data shall be transmitted, the present time-division switching time slot acquires data from corresponding time-division switch transmission queue; if it is found that an idle time fragment is acquired, the time slots shall wait for the next transmission period without transmitting any data during the waiting, i.e., keeping line idle in the time slot. If an Ethernet frame of fixed length is acquired, the Ethernet frame shall be transmitted.

In practical applications, when it is found that an idle time fragment is acquired from a time-division switching time slot, the to-be-transmitted Ethernet frame in the packet switch transmission queue of the same Ethernet port can be transmitted while the time slots waits for the next transmission period, hence the bandwidth utility ratio can be improved.

When a burst service is transmitted during the idle time fragment of the time-division switching time slot, as the L2/L3 information of the Ethernet frame of the burst service is different from that of the Ethernet frame of fixed length of the time-division service, a downstream device can still recognize the Ethernet frame in the packet switching based on L2/L3 information of the frame upon receipt of the Ethernet frame of the burst service from the time-division switching time slot; furthermore, the Ethernet frame will still be placed in corresponding packet switch transmission queue without interrupting the time-division switching of time-division services when the Ethernet frame should be switched again. Therefore a time slot may carry both the sub-slot-rate time-division service stream and the packet service stream.

It can be seen that multiple sub-slot-rate time-division services with different L2/L3 information can be multiplexed in different time fragments of one transmission time slot, i.e., a time slots may carry more than one sub-slot-rate time-division service streams at intervals.

In the preceding two embodiments, one time-division switching time slot is used for the transmission of one Ethernet frame of fixed length. In practical applications, multiple consecutive time-division switching time slots may be concatenated as a complex time-division switching time slot for a service stream and the complex time-division switching time slot is able to carry longer Ethernet frame of fixed length. For example, 3 consecutive time-division switching time slots of 500 μs, the length of which is set for Ethernet frames of a fixed length of 625 bytes, are bound into a complex time-division switching time slot which can carry an Ethernet frame of a fixed length of 625×3=1875 bytes. When the IFG is 16 bytes long, the Frame payload length of the Ethernet frame of fixed 1875 bytes is 1875−7−1−16=1851 bytes. The complex time-division switching time slot for longer Ethernet frame of fixed length can provide higher transmission rate. Obviously, the complex time-division switching time slot can also carry three Ethernet frames of fixed 625 bytes in the same service stream.

In such case, as shown in FIG. 4, a time-division service stream may, based on the bandwidth demand, occupy one or multiple transmission time slots. For example, a time-division service stream may occupy n consecutive transmission time slots among totally k transmission time slots, wherein n<k, hence the n transmission time slots shall be bound into one complex time-division switching time slot in which one or multiple Ethernet frames of fixed length can be transmission in one cycle and the time-division service stream thus occupies n/k of the total bandwidth of the Ethernet port.

When complex time-division switching time slot is adopted, a complex time-division switching time slot shall maintain one time-division switch transmission queue. Upon expiration of a transmission interval of the complex time-division switching time slot, Ethernet frame(s) of fixed length is acquired from the time-division switch transmission queue maintained in the complex time-division switching time slot and is transmitted. Each of the time-division switching time slots that make up the complex time-division switching time slot corresponds to a part of the Ethernet frame of fixed length and transmits the corresponding part of the Ethernet frame of fixed length when the transmission interval of the complex time-division switching time slot expires.

The present invention also provides an Ethernet switch to implement the Ethernet switching method provided by the present invention.

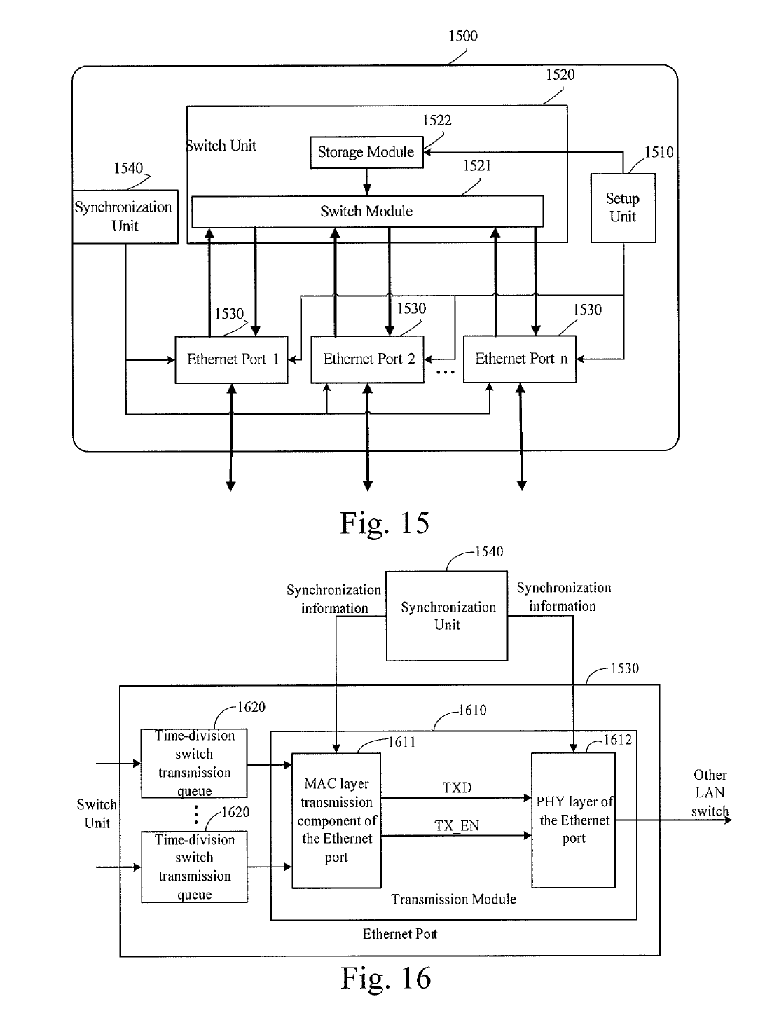

FIG. 15 is a schematic illustrating the structure of the Ethernet switch in Embodiment 1 of the present invention. As shown in FIG. 15, the Ethernet Switch 1500 includes Setup Unit 1510, Switch Unit 1520 and n (n≧2) Ethernet Ports 1530, wherein

the Setup Unit 1510 is adapted to divide the communication period of the transmitting component of each Ethernet Port 1530 into at least two equal transmission time slots that appear periodically, and send the relations between the L2/L3 information and the transmission time slots of the Ethernet ports to the Switch Unit 1520; and

the Switch Unit 1520 is adapted to determine the transmission time slot corresponding to a to-be-switched Ethernet frame of fixed length at corresponding Ethernet port based on the relation between the received L2/L3 information and the transmission time slot of the Ethernet port, and to switch the to-be-switched Ethernet frame to the time-division switch transmission queue maintained in corresponding transmission time slot at corresponding Ethernet port.

The Switch Unit 1520 further includes Switch Module 1521 and Storage Module 1522, wherein

the Storage Module 1522 is adapted to store a forwarding table recording the relations between the L2/L3 information and the transmission time slots of the Ethernet ports; and the Switch Module 1521 is adapted to determine, based on the relations acquired from the forwarding table in the Storage Module 1522, the transmission time slot at the Ethernet port corresponding to the L2/L3 information of the to-be-switched Ethernet frame of fixed length, and to switch the to-be-switched Ethernet frame of fixed length into the time-division switch transmission queue maintained by the determined Ethernet port in the determined transmission time slot.

The receiving components of the Ethernet Ports 1530 are adapted to receive Ethernet frames of fixed length.

An Ethernet Port 1530 transmits in a cyclic order the to-be-switched Ethernet frames of fixed length in time-division switch transmission queues maintained in different transmission time slots separately. To be specific, when the Ethernet Port 1530 decides that the transmission interval of a transmission time interval expires, the Ethernet Port 1530 transmits the Ethernet frame of fixed length in the transmission time slot. Each of the transmission time slots of an Ethernet port maintains a time-division switch transmission queue to buffer switched Ethernet frame of fixed length which is decided to be transmitted in the time slot.

The Ethernet Port 1530 still adopts the conventional MAC+PHY structure. FIG. 16 is a schematic illustrating the structure of the transmitting component of Ethernet Port 1530 in FIG. 15. As shown in FIG. 16, the transmitting component of the Ethernet Port 1530 includes Transmission Module 1610 and Time-Division Switch Transmission Queues 1620 in the transmission time slots. A Time-Division Switch Transmission Queue 1620 is adapted to buffer the Ethernet frames of fixed length that are switched to the time slot corresponding to the time-division switch transmission queue. The Transmission Module 1610 is adapted to judge, in a cyclic order, whether the transmission intervals of the time slots expire and to transmit the to-be-transmitted Ethernet frame of fixed length in the Time-Division Switch Transmission Queue 1620 maintained by the transmission time slot whose transmission interval expires.

The Transmission Module 1610 further includes MAC Layer Transmission Component 1611 of the Ethernet port and the PHY Layer 1612 of the Ethernet port. The MAC Layer Transmission Component 1611 of the Ethernet port calculates the starting time of the transmission of the time slots based on the length of the Ethernet frame of fixed length, the number of all transmission time slots and the clock period of the local clock of the Ethernet port, and enables the transmission enable signal TX_EN that controls the data transmission at the Ethernet port when the transmission of a time slot should starts. When the TX_EN is enabled, the PHY 1612 of the Ethernet port sends an Ethernet frame of fixed length TXD through a time slot. The period in which the TX_EN is enabled shall appear regularly so that the transmitting component of the Ethernet port can obtain transmission time slots based on the transmission time of Ethernet frames of fixed length and transmit and schedule Ethernet frames of fixed length according to the length of transmission time slots.

In practical applications, as shown in FIG. 15, the Ethernet Switch 1500 may further includes Synchronization Unit 1540 adapted to provide acquired synchronization information for the Ethernet Ports 1530. The MAC Layer Transmission Component 1611 of an Ethernet port adjusts the local clock according to the received synchronization clock. The synchronization information ensures that the Ethernet switch is synchronized with the upstream and downstream devices. The synchronization information can be acquired by calculating when an Ethernet frame of fixed length is transmitted and received, or be acquired from the clock of the upstream device, or from the synchronization system of GPS, or from the synchronization network on the PDH or SDH.

Furthermore, the Ethernet Ports 1530 in the Ethernet switching in accordance with the present invention may have the same local clock rate, or the local clock rate of one Ethernet port may be the multiple of the local clock rate of another Ethernet port.

The Ethernet switch shown in FIG. 15 can also be used in the preceding Embodiment 2 to carry out the Ethernet switching method in accordance with the present invention.

Compared with the Ethernet switch in Embodiment 1, the Ethernet switch of Embodiment 2 has the unique feature that the Setup Unit 1510 further designates some transmission time slots as the time slots for time-division switching after obtaining the time slots and sends the designation information to corresponding Ethernet Port 1530.

In such case, the forwarding table stored in the Storage Module 1522 stores not only the relations between the L2/L3 information of the Ethernet frames of fixed length for time-division switching and the transmission time slots at the Ethernet ports, but also the relations between the L2/L3 information of the Ethernet frames for packet switching and the Ethernet ports.

The Switch Module 1521 is adapted to receive incoming Ethernet frames of fixed length for time-division switching and/or Ethernet frames for packet switching from the receiving components of the Ethernet ports, to acquire L2/L3 information from the Ethernet frames of fixed length for time-division switching, to search the forwarding table based on the acquired L2/L3 information and to switch the Ethernet frames of fixed length for time-division switching to corresponding transmission time slot at corresponding Ethernet port based on the relations recorded in the forwarding table for switching the Ethernet frames of fixed length for time-division switching; or, to acquire L2/L3 information from the Ethernet frames for packet switching, to search the forwarding table based on the acquired L2/L3 information and to switch the Ethernet frames for packet switching to corresponding Ethernet port based on the relations recorded in the forwarding table for switching the Ethernet frames for packet switching.

The receiving components of the Ethernet Ports 1530 receive incoming Ethernet frames of fixed length for time-division switching and/or Ethernet frames for packet switching.

The transmission time slots for time-division switching at the Ethernet Ports 1530 transmit the Ethernet frames in the time-division switch transmission queues of the transmission time slots whose transmission intervals expire, just like in Embodiment 1. The time slots that are not designated as the time slots for time-division switching are regarded by default the time slots for packet switching which transmit the to-be-transmitted Ethernet frames in the packet switch transmission queues of the Ethernet ports at which the transmission intervals of the time slots expire.

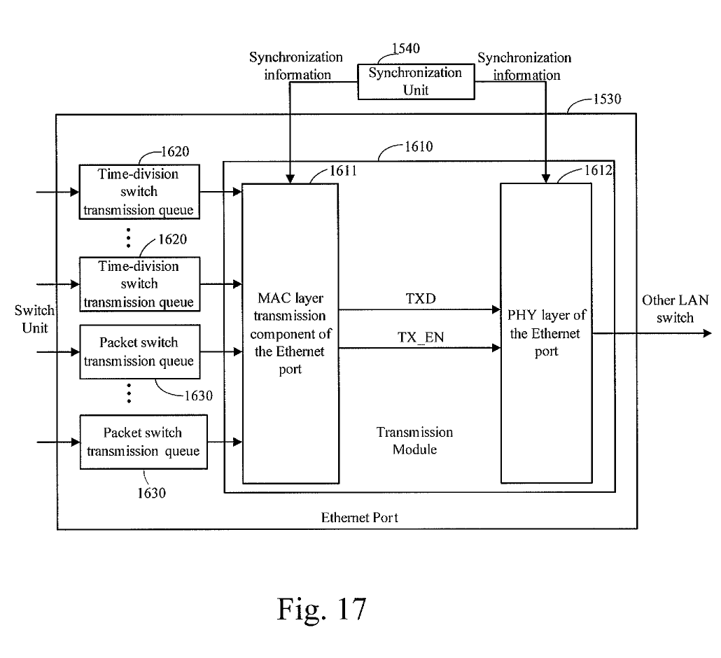

FIG. 17 shows the structure of the Ethernet Port 1530 in this embodiment. As shown in FIG. 17, the Ethernet Port 1530 is different from the one shown in FIG. 16 in that the Ethernet Port 1530 in this embodiment further includes at least one Packet Switch Transmission Queue 1630 to buffer the Ethernet frames switched to the Ethernet Port 1530 for packet switching.

Upon the expiration of the transmission interval of a time slot, the Transmission Module 1610 judges whether the time slot is designated as a time slot for time-division transmission and transmits the Ethernet frame of fixed length in the Time-Division Switch Transmission Queues 1620 of the time slot if the time slot is designated as a time slot for time-division transmission, otherwise the Transmission Module 1610 transmits the to-be-transmitted Ethernet frame in the Packet Switch Transmission Queue 1630 at the Ethernet port of the time slot.

In practical applications, the transmitting component of an Ethernet port maintains m Packet Switch Transmission Queues 1630 of different priority levels to buffer Ethernet frames for packet switching, wherein m≧1. Before the Transmission Module 1610 of the Ethernet Port 1530 transmits the to-be-transmitted Ethernet frame in the Packet Switch Transmission Queue 1630, a queue shall be chosen from the m packet switch transmission queues of the Ethernet Port 1530 based on a predetermined priority policy and the to-be-transmitted Ethernet frame in the chosen Packet Switch Transmission Queue 1630 shall be transmitted.

In practical applications, the Time-Division Switch Transmission Queues 1620 is not a simple FIFO queue in that the Time-Division Switch Transmission Queues 1620 may identify the time fragment in which no data packet is received as idle time fragment. When the Transmission Module 1610 reads an idle time fragment in the Time-Division Switch Transmission Queues 1620, the Transmission Module 1610 transmits no data and waits for the next transmission time slot, or the Transmission Module 1610 acquires the to-be-transmitted Ethernet frame in the m Packet Switch Transmission Queues 1630 of the Ethernet Port 1530 according to the priority policy and transmits the Ethernet frame.

It can be seen from the above that the present invention is able to achieve synchronized time-division switching over Ethernet and satisfy the transmission delay requirement of time-division services transmitted at constant rate by utilizing Ethernet switching mechanism. In addition, the Ethernet switch can combine synchronized time-division switching and packet switching and set the bandwidths occupied by time-division switching and packet switching flexibly.

Furthermore, some transmission time slots of the Ethernet ports are allocated to the time-division switching of time-division service transmission while other transmission time slots are allocated to the packet switching of burst service transmission. The transmission time slots allocated to the time-division switching are associated with different time-division service streams for the transmission of Ethernet frames of fixed length, and the transmission time slots allocated to the packet switching are used for the transmission of conventional Ethernet frames in packet switching. Two or more than two consecutive transmission time slots allocated to the packet switching may function as one packet switching time fragment in the packet switching. In this way the Ethernet switching method of the present invention is suitable for the transmission of time-division services at constant rate as well as the transmission of burst services, therefore the integrated transmission of time-division service and packet services is achieved.

The basic unit of Ethernet switching in accordance with the present invention is an Ethernet frame of fixed length, which provides higher transmission rate than the conventional unit of bytes does in time-division switching. And the cost of Ethernet networks is low, so the Ethernet switching method of the present invention shows higher performance/cost ratio than the conventional time-division switching scheme.

The Ethernet switching method of the present invention only requires the Ethernet ports to have the same frequency or to have frequencies that are multiples of the frequencies of other Ethernet ports adopted by the method, so the Ethernet switching scheme of the present invention is very flexible.

The foregoing is only a preferred embodiment of this invention, and is not for use in limiting the invention. Any modification, equivalent replacement or improvement made under the spirit and principles of this invention should be covered within the protection scope of this invention.

What is claimed is:

1. An Ethernet switching method, comprising:
dividing a communication period of a transmitting component of an Ethernet port into at least two time-division services switch slots that appear periodically;
deciding a transmission time slot at the Ethernet port corresponding to Layer 2/Layer 3 (L2/L3) information of each to-be-switched Ethernet frame of fixed length;
switching each to-be-switched Ethernet frame of fixed length into a time-division switch transmission queue maintained in the decided transmission time slot of the Ethernet port; and
transmitting, by the Ethernet port in a cyclic order, each to-be-switched Ethernet frame of fixed length in time-division services switch transmission queues maintained in each transmission time slot separately.

2. The method according to claim 1, wherein one time-division switch transmission queue is maintained in one transmission time slot; or one time-division switch transmission queue is maintained in more than one concatenated consecutive transmission time slots.

3. The method according to claim 1, further comprising:
maintaining at least one packet switch transmission queue in the Ethernet port; and
designating at least one transmission time slot for time-division switching and at least one transmission time slots for packet switching, after dividing the communication period of the transmitting component of an Ethernet port into at least two equal transmission time slots that appear periodically.

4. The method according to claim 3, further comprising:
judging, while transmitting in a cyclic order each to-be-transmitted Ethernet frame in the time-division switch transmission queues maintained in the transmission time slots, whether the transmission time slot through which an Ethernet frame is to be transmitted is designated as a transmission time slot for time-division switching,
transmitting a to-be-transmitted Ethernet frame of fixed length in the time-division switch transmission queue maintained in the transmission time slot through which an Ethernet frame is to be transmitted if the transmission time slot is designated as a transmission time slot for time-division switching, or
transmitting one or more to-be-transmitted Ethernet frames in the packet switch transmission queue maintained by the Ethernet port which has the transmission time slot through which an Ethernet frame is to be transmitted if the transmission time slot is designated as a transmission time slot for packet switching.

5. The method according to claim 2, further comprising:
identifying a part without data to be transmitted in the time-division switch transmission queue as an idle time fragment;
judging, before transmitting an Ethernet frame of fixed length in a transmission time slot, whether an idle time fragment is acquired from the time-division switch transmission queue maintained in the transmission time slot through which an Ethernet frame is to be transmitted;
waiting for the next transmission time slot if an idle time fragment is acquired; or
acquiring an Ethernet frame from the time-division switch transmission queue and transmitting the Ethernet frame if an idle time fragment is not acquired.

6. The method according to claim 5, further comprising:
transmitting, while waiting for the next transmission time slot, a to-be-transmitted Ethernet frame in a packet switch transmission queue maintained by the Ethernet port when an idle time fragment is acquire.

7. The method according to claim 4, wherein transmitting the to-be-transmitted Ethernet frame in a packet switch transmission queue maintained by the Ethernet port comprises:
a1: acquiring the transmission time of the to-be-transmitted Ethernet frame in the packet switch transmission queue maintained by the Ethernet port;
a2: calculating the length of the time between the present and the data transmission period of the next transmission time slot for time-division switching;
a3: judging whether the transmission time of the to-be-transmitted Ethernet frame is shorter than or equal to the length of the time calculated in a2, proceeding to a4 if the transmission time is shorter than or equal to the length of the time calculated in a2, otherwise terminating the process;
a4: transmitting the acquired to-be-transmitted Ethernet frame; and
a5: acquiring the transmission time of the present to-be-transmitted Ethernet frame in the packet switch transmission queue maintained by the Ethernet port and returning to a2.

8. The method according to claim 3, wherein the Ethernet port maintains at least two packet switch transmission queues of different priority levels, and the method further comprises:
choosing, before a transmission time slot for packet switching shall transmit data, a packet switch transmission queue among the packet switch transmission queues maintained by the Ethernet port, and
transmitting a to-be-transmitted Ethernet frame in the chosen packet switch transmission queue.

9. The method according to claim 1, wherein the Ethernet port has the same frequency with other Ethernet ports of a same Ethernet switch, or the frequency of the Ethernet port is the multiple of the frequency of another Ethernet port of a same Ethernet switch, and the lengths of the Ethernet frames of fixed length processed by the all Ethernet ports are the same.

10. The method according to claim 1, further comprising:
calculating the starting time of the transmission periods of different transmission time slots respectively based on the length of the Ethernet frames of fixed length, the number of the transmission time slots and the clock period of the local clock of the Ethernet port; and
transmitting a to-be-transmitted Ethernet frame of fixed length in the time-division switch transmission queue maintained in the transmission time slot whose transmission period starts.

11. The method according to claim 1, further comprising:
a: acquiring synchronization information by calculating the transmitting time and receiving time of the Ethernet frame of fixed length, or by extracting the clock of an upstream device, or through the synchronization system of the Global Positioning System (GPS), or through the synchronization network on Plesiochronous Digital Hierarchy (PDH) or Synchronous Digital Hierarchy (SDH); and
b: adjusting the local clock of the Ethernet port according to the acquired synchronization information.

12. The method according to claim 1, further comprising:
deciding the length and format of the Ethernet frame of fixed length in advance, and
encapsulating to-be-transmitted data into Ethernet frames of fixed length based on the decided length and format.

13. The method according to claim 12, wherein encapsulating the to-be-transmitted data into Ethernet frames comprises:
judging whether the length of the to-be-transmitted Ethernet frame is shorter than or equal to the length of the Ethernet frame of fixed length,
encapsulating the to-be-transmitted data into an Ethernet frame of fixed length and filling the unfilled part of the Ethernet frame with null data if the length of the to-be-transmitted Ethernet frame is shorter than or equal to the length of the Ethernet frame of fixed length, or
fragmenting the to-be-transmitted data into more than one fragment by using fragmenting method and encapsulating the fragments by using the format of the Ethernet frame of fixed length if the length of the to-be-transmitted Ethernet frame is longer than the length of the Ethernet frame of fixed length.

14. The method according to claim 13, wherein filling the unfilled part of the Ethernet frame with null data comprises:
filling the null data into pad field or extension field or inter frame gap.

15. The method according to claim 13, wherein fragmenting the to-be-transmitted data into more than one fragment by using fragmenting method comprises:
fragmenting the to-be-transmitted data into more than one fragment by using IP packet fragmenting method or MAC frame fragmenting method.

16. The method according to claim 15, wherein, when the MAC frame fragmenting method is adopted, a fragment obtained shall include extended frame header which further include: fragment type that identifies the Ethernet frame of fixed length as a fragment, and fragment deviation that indicates the location of the Ethernet frame in the fragmented to-be-transmitted data.

17. An Ethernet switch, comprising a setup unit, a switch unit and at least two Ethernet ports; wherein
the setup unit is adapted to divide a communication period of a transmitting component of each Ethernet port into at least two equal transmission time slots that appear periodically, and to send relations between Layer 2/Layer 3 (L2/L3) information and the transmission time slots of each Ethernet port to the switch unit;
the switch unit is adapted to determine, based on the received relations, the transmission time slot at each Ethernet port corresponding to the L2/L3 information of each to-be-switched Ethernet frame of fixed length, and to switch each to-be-switched Ethernet frame of fixed length into a time-division switch transmission queue maintained by the determined Ethernet port in the determined transmission time slot; and
each Ethernet port is adapted to transmit in a cyclic order each to-be-switched Ethernet frame of fixed length in time-division switch transmission queues maintained in the transmission time slots separately.

18. The switch according to claim 17, wherein the switch unit comprises:
a storage module, adapted to record the relation between the L2/L3 information and the transmission time slots of the Ethernet ports; and
a switch module, adapted to determine, based on the relations acquired from the storage module, the transmission time slot and the Ethernet port corresponding to the L2/L3 information of a to-be-switched Ethernet frame of fixed length, and to switch the to-be-switched Ethernet frame of fixed length into the time-division switch transmission queue maintained by the determined Ethernet port in the determined transmission time slot.

19. The switch according to claim 17, wherein the transmitting component of an Ethernet port comprises:
at least one time-division switch transmission queue, each adapted to buffer switched to-be-transmitted Ethernet frames of fixed length; and
a transmission module, adapted to transmit in a cyclic order the to-be-transmitted Ethernet frames of fixed length in the at least one time-division switch transmission queue maintained in the transmission time slots separately.

20. The switch according to claim 19, wherein the transmitting component of the Ethernet port comprises at least one packet switch transmission queue adapted to buffer switched Ethernet frames to be transmitted for packet switching.

21. The switch according to claim 20, wherein the setup unit is further adapted to designate transmission time slots for time-division switching and transmission time slots for packet switching, and to send the designation information to the Ethernet port; and
the transmission module is further adapted to transmit, upon receipt of the designation information indicating that the transmission time slot through which data are to be transmitted is designated as the transmission time slot for packet switching, a to-be-transmitted Ethernet frame in the packet switch transmission queue maintained by the Ethernet port of the transmission slot through which data are to be transmitted.

22. The switch according to claim 20, wherein a time-division switch transmission queue is further adapted to identify a part without any data to be transmitted in the queue as an idle time fragment; and
the transmission module shall wait for the next transmission time slot or transmit the to-be-transmitted Ethernet frame in the packet switch transmission queue maintained by the Ethernet port of the transmission time slot when it is judged that an idle time fragment is acquired from the time-division switch transmission queue.

23. The switch according to claim 21, wherein the transmitting component of one of the Ethernet port maintains at least two packet switch transmission queues of different priority levels; and
the transmission module is further adapted to choose a packet switch transmission queue from all packet switch transmission queues maintained by the Ethernet port of the transmission time slot through which data are to be transmitted, and to transmit the to-be-transmitted Ethernet frame in the chosen packet switch transmission queue.

24. The switch according to claim 19, wherein the transmission module comprises:
Media Access Control (MAC) layer, adapted to calculate the starting time of the transmission periods of different transmission time slots based on the length of Ethernet frames of fixed length, the number of transmission time slots and the clock period of the local clock of the Ethernet port, and to enable the transmission enabling signal TX_EN that controls the data transmission of the Ethernet port when the transmission period of a time slot should starts.

25. The switch according to claim 17, further comprising:
a synchronization unit, adapted to provide synchronization information for Ethernet ports to adjust local clocks.

26. The switch according to claim 17, wherein the Ethernet ports in the Ethernet switching have the same frequency, or the frequency of one Ethernet port is the multiple of the frequency of another Ethernet port and the number of the transmission time slots of the Ethernet port whose frequency is the multiple of the frequency of another Ethernet port is the multiple of the number of the transmission time slots of the another Ethernet port; and the lengths of the Ethernet frames of fixed length processed by the Ethernet ports are the same.
